(19) United States
(12) Patent Application Publication
(10) Pub. No.: US 2026/0073138 A1
(43) Pub. Date: Mar. 12, 2026

(54) ANOMALY DETECTION APPARATUS, METHOD, AND STORAGE MEDIUM

(71) Applicants: KABUSHIKI KAISHA TOSHIBA, Kawasaki-shi (JP); Toshiba Digital Solutions Corporation, Kawasaki-shi (JP)

(72) Inventors: Toshiki NAKASHIMA, Kawasaki Kanagawa (JP); Ryo KIYAMA, Koza Kanagawa (JP)

(73) Assignees: KABUSHIKI KAISHA TOSHIBA, Kawasaki-shi (JP); Toshiba Digital Solutions Corporation, Kawasaki-shi (JP)

(21) Appl. No.: 19/314,297

(22) Filed: Aug. 29, 2025

(30) Foreign Application Priority Data
Sep. 12, 2024 (JP) 2024-158310

(51) Int. Cl. G06F 40/279; G06F 18/23; G06F 40/242

(52) U.S. Cl. CPC G06F 40/279; G06F 18/23; G06F 40/242

(57) ABSTRACT

According to one embodiment, an anomaly detection apparatus includes a processor. The processor acquires a first sample that is a subject for anomaly detection. The processor generates, using a trained model, a first text from the first sample. The first text represents a content of the first sample. The processor determines whether the first sample has an anomaly based on a statistic associated with all or a part of the first text in a dictionary. The dictionary associates all or a part of a second text representing a content of a second sample included in a training data set with a statistic related to a degree of appearance of all or a part of the second text in the training data set. The processor outputs a determination result.

### CROSS-REFERENCE TO RELATED APPLICATION

This application is based upon and claims the benefit of priority from Japanese Patent Application No. 2024-158310, filed Sep. 12, 2024, the entire contents of which are incorporated herein by reference.

### FIELD

Embodiments described herein relate generally to an anomaly detection apparatus, method, and storage medium.

### BACKGROUND

In recent years, there is an increasing need for detecting anomaly using footage from a surveillance camera, etc. In particular, the unsupervised anomaly detection that uses only a normal image for training has advantages that an anomaly image and an annotation are unnecessary at the time of training, and that an unknown anomaly can be detected. On the other hand, the unsupervised anomaly detection has difficulty in detecting anomaly with high accuracy in a case where there is a change in an imaging environment such as a change in a position or an angle of a camera that performs image capture or a change in a sunshine condition due to a change in a period of time in which image capture is performed.

### BRIEF DESCRIPTION OF DRAWINGS

FIG. 1 is a functional block diagram illustrating an example of an anomaly detection apparatus according to a first embodiment.

FIG. 2 is a diagram illustrating a flow of processing performed by the anomaly detection apparatus according to the first embodiment at the time of training.

FIG. 3 is a diagram illustrating an example of a training data set according to the first embodiment.

FIG. 4 is a diagram illustrating a flow of processing performed by the anomaly detection apparatus according to the first embodiment at the time of anomaly detection.

FIG. 5 is a diagram illustrating an example of an inference data set according to the first embodiment.

FIG. 6 is a diagram illustrating an example of a display screen indicating a determination result according to the first embodiment.

FIG. 7 is a functional block diagram illustrating an example of an anomaly detection apparatus according to a third embodiment.

FIG. 8 is a diagram illustrating a flow of processing performed by the anomaly detection apparatus according to the third embodiment at the time of training.

FIG. 9 is a diagram illustrating an example of a training data set according to the third embodiment.

FIG. 10 is a diagram illustrating an example of a text information dictionary according to the third embodiment.

FIG. 11 is a diagram illustrating a flow of processing performed by the anomaly detection apparatus according to the third embodiment at the time of anomaly detection.

FIG. 12 is a diagram illustrating an example of an inference data set according to the third embodiment.

FIG. 13 is a functional block diagram illustrating an example of an anomaly detection apparatus according to a fourth embodiment.

FIG. 14 is a functional block diagram illustrating an example of an anomaly detection apparatus according to a fifth embodiment.

FIG. 15 is a functional block diagram illustrating an example of an anomaly detection apparatus according to a sixth embodiment.

FIG. 16 is a diagram illustrating a flow of processing performed by the anomaly detection apparatus according to the sixth embodiment at the time of anomaly detection.

FIG. 17 is a diagram illustrating an example of an inference data set according to the sixth embodiment.

FIG. 18 is a diagram illustrating an example of a result of zero-shot object detection according to the sixth embodiment.

FIG. 19 is a diagram illustrating an example of a display screen indicating an anomaly-point visualization image and a determination result according to the sixth embodiment.

FIG. 20 is a functional block diagram illustrating an example of an anomaly detection apparatus according to a seventh embodiment.

FIG. 21 is a diagram illustrating a flow of processing performed by the anomaly detection apparatus according to an eighth embodiment at the time of anomaly detection.

FIG. 22 is a diagram illustrating an example of a training data set according to the eighth embodiment.

FIG. 23 is a diagram illustrating an example of an inference data set according to the eighth embodiment.

FIG. 24 is a functional block diagram illustrating an example of an anomaly detection apparatus according to a ninth embodiment.

FIG. 25 is a diagram illustrating a flow of processing performed by the anomaly detection apparatus according to the ninth embodiment at the time of training.

FIG. 26 is a diagram illustrating an example of a training data set according to the ninth embodiment.

FIG. 27 is a diagram illustrating a flow of processing performed by the anomaly detection apparatus according to the ninth embodiment at the time of anomaly detection.

FIG. 28 is a diagram illustrating an example of an inference data set according to the ninth embodiment.

FIG. 29 is a functional block diagram illustrating an example of an anomaly detection apparatus according to a tenth embodiment.

FIG. 30 is a diagram illustrating an example of a hardware configuration of the anomaly detection apparatus according to the present embodiment.

### DETAILED DESCRIPTION

An anomaly detection apparatus according to embodiments includes an acquisition unit, a generation unit, a detection unit, and an output unit. The acquisition unit acquires a first sample that is a subject for anomaly detection. The generation unit generates a first text representing the content of the first sample from the first sample using a trained model. The detection unit determines whether or not the first sample has an anomaly based on a statistic associated with all or a part of the first text in a text information dictionary. The text information dictionary associates all or a part of a second text representing the content of a second sample included in a training data set with a statistic related to a degree of appearance of all or a part of the second text in the training data set. The output unit outputs a determination result of whether or not the first sample has an anomaly.

An anomaly detection apparatus, method, and storage medium according to the present embodiments will be described below with reference to the drawings.

### First Embodiment

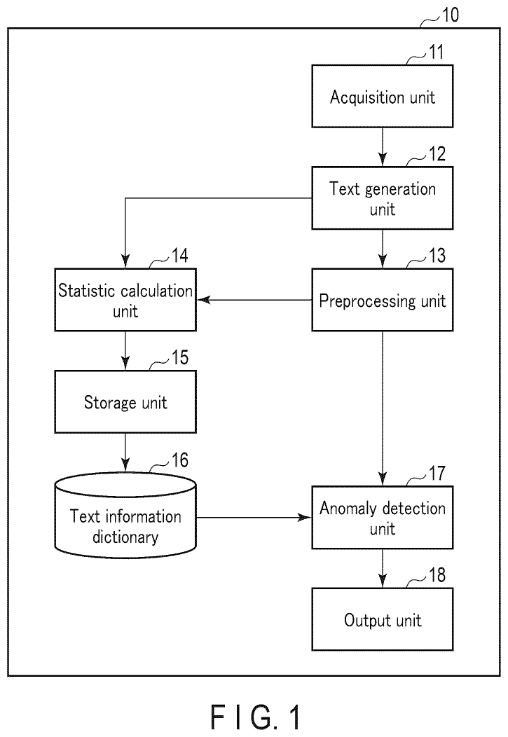

FIG. 1 is a functional block diagram illustrating an example of an anomaly detection apparatus 10 according to the first embodiment. The anomaly detection apparatus 10 is a computer that trains a text information dictionary using a training sample and determines the occurrence of an anomaly in a sample that is a subject for anomaly detection using the text information dictionary. The sample according to the present embodiment means data represented as a vector or a multidimensional tensor, such as image data, time-series video, and audio signals. In the following description, the sample is assumed to be image data. The image data is also simply referred to as an image. As illustrated in FIG. 1, the anomaly detection apparatus 10 includes an acquisition unit 11, a text generation unit 12, a preprocessing unit 13, a statistic calculation unit 14, a storage unit 15, a text information dictionary 16, an anomaly detection unit 17, and an output unit 18.

The acquisition unit 11 acquires a sample. At the time of training, the acquisition unit 11 acquires a training data set. The training data set includes a plurality of training samples. The training sample means a sample used for training an anomaly detection model. In the following description, it is assumed that the training data set includes only a normal sample, but the training data set may include both a normal sample and an anomaly sample. The normal sample means a sample determined as normal by any means, and the anomaly sample means a sample determined as anomaly by any means. During anomaly detection, the acquisition unit 11 acquires a sample that is a subject for anomaly detection. The sample that is the subject for anomaly detection is hereinafter referred to as a target sample. Specifically, the acquisition unit 11 acquires an inference data set including one or more target samples. When doing so, the acquisition unit 11 may collectively acquire a plurality of samples as one batch. Hereinafter, when the training sample and the target sample are not distinguished from each other, they are simply referred to as a sample.

In a case where it is desired to detect an object that does not normally appear as an anomaly in a situation where an outdoor surveillance camera captures a landscape of a certain place, it is assumed that the training data set includes a large number of images that do not include such an object. Furthermore, in a case where it is desired to detect a defect of a subject in a certain captured image, it is assumed that the training data set includes a large number of images of the same object not including such a defect.

The text generation unit 12 generates, from the sample acquired by the acquisition unit 11, a text representing the content of the sample using a trained model. The text according to the present embodiment means character information indicating the content of the sample. Specifically, the text includes a sentence, a word, a combination of words, a clause including a plurality of words, and a dependency relationship. As the trained model, a machine learning model (hereinafter referred to as text generation model) trained to input a sample and output a text representing the content of the sample is used. In a case where the sample is an image, a so-called image-to-text model that converts the image into a text representing the content of the image can be used as the text generation model. Specifically, examples of the image-to-text model that can be used include a caption generation model, a visual question answering (VQA) model, and a multimodal large language model (LLM) using a prompt. The caption generation model is, as an example, a machine learning model trained to input an image and output a caption that is an explanatory sentence of the content of the image. The visual question answering model is a machine learning model trained to input a sample and a prompt that is a question sentence for the content of the sample and output an answer sentence for the question sentence. Hereinafter, the text based on the training sample is referred to as a training text, and the text based on the target sample is referred to as a target text. When the training text and the target text are not distinguished from each other, the training text and the target text are simply referred to as a text.

The preprocessing unit 13 performs any preprocessing on the text generated by the text generation unit 12. The preprocessing includes, as an example, segmentation processing of segmenting the text into a plurality of sections and/or exclusion processing of excluding information unnecessary for anomaly detection from the text. Here, the “section” means any sentence constituent shorter than the input text, such as a word, a combination of words, a clause including a plurality of words, or a dependency relationship. Specifically, the segmentation processing segments the text into a plurality of words. Another example of the preprocessing includes processing of identifying the part of speech of each word generated by the segmentation processing and extracting a word of a specific part of speech. Here, any part of speech such as a noun, an adjective, or a verb can be set as the specific part of speech. Furthermore, the specific part of speech is not limited to one type, and a plurality of types of part of speech such as a combination of noun and adjective may be set as the specific part of speech. Another example of the preprocessing may include processing of correcting a plural noun to a singular noun. Another example of the preprocessing may include processing of pairing an adjective and a noun modified by the adjective. In this processing, the adjective alone and the noun alone may be output separately from the pair of the adjective and the noun. For example, three sentence constituents “cute”, “dog”, and “cute dog” may be output from the sentence “cute dog”. Another example of the preprocessing may include processing of, in a case where the same word appears twice or more in one sentence, outputting the word without duplication.

Note that the preprocessing unit 13 is not always necessary, and subsequent processing may be performed on the text generated by the text generation unit 12. For example, in a case where the text generated by the text generation unit 12 is not a sentence but a word, the preprocessing unit 13 can be omitted.

The statistic calculation unit 14 calculates a statistic of all or a part of the training text for each of the plurality of training samples. The statistic according to the present embodiment means an index related to the degree of appearance of all or a part of the training text in the training data set. The term “a part of the text” means any sentence constituent such as a word, a combination of words, a clause including a plurality of words, or a dependency relationship. As an example, the statistic calculation unit 14 calculates the probability of appearance of the word output by the preprocessing unit 13. The probability of appearance is an example of a statistic. Specifically, first, the statistic calculation unit 14 calculates the frequency of appearance of all or a part of the training text corresponding to each of the plurality of training samples included in the training data set, and calculates the statistic based on the calculated frequency of appearance. The frequency of appearance means the number of appearances. For example, in a case where a part of the training text is words, each of the words appearing in the training text corresponding to each training sample included in the training data set is counted. The count number of the word is an example of the frequency of appearance. After finishing the count in the entire training data set, the statistic calculation unit 14 calculates the probability of appearance of each word by dividing the frequency of appearance of each word by the number of training samples.

The statistic calculation unit 14 may count the appearing words not on a word basis but for each combination (hereinafter referred to as word pair) of a plurality of types of words included in one text. For example, in a case where one text includes three types of words “dog”, “cat”, and “human”, three types of word pairs (dog, cat), (cat, human), and (dog, human) may be counted. In this case, the statistic calculation unit 14 calculates the co-occurrence probability of each word pair by dividing the frequency of appearance of the word pair by the number of training samples. The word pair is an example of a “a part of text”, and the co-occurrence probability is an example of a statistic.

The statistic calculation unit 14 may calculate the conditional joint probability by dividing the co-occurrence probability of the word pair by the probability of appearance of the word constituting the word pair. As an example, the conditional joint probability of “dog” and “cat” can be calculated by the following Expression (1). The conditional joint probability is an example of a statistic.

$$p ( dog , cat ) = \frac{p ( dog , cat )}{p ( dog ) p ( cat )} \qquad ( 1 )$$

### Conditional Joint Probability

The statistic calculation unit 14 may count each of texts corresponding to training samples included in the training data set. After finishing the count in the entire training data set, the statistic calculation unit 14 calculates the probability of appearance of each text by dividing the frequency of appearance of each text by the number of training samples.

The storage unit 15 is a storage apparatus that stores the text information dictionary 16. The text information dictionary 16 associates all or a part of the training text representing the content of the training sample included in the training data set with a statistic related to the degree of appearance of all or a part of the training text in the training data set. All or a part of the training text means the entire text, clauses, the dependency relationship, words, and/or word pairs of the training text, and the statistic means the probability of appearance, the co-occurrence probability, and/or the conditional joint probability calculated by the statistic calculation unit 14. The text information dictionary 16 is created as a table or database that associates all or a part of the training text with the statistic.

The anomaly detection unit 17 determines whether or not the target sample has an anomaly based on the statistic associated with all or a part of the target text corresponding to the target sample in the text information dictionary 16. Specifically, the anomaly detection unit 17 calculates an anomaly score of the target text based on the statistic associated with all or a part of the target text. Then, the anomaly detection unit 17 determines the target sample as anomaly in a case where the anomaly score is larger than a threshold, and determines the target sample as normal in a case where the anomaly score is smaller than the threshold. The threshold may be freely set according to a user's instruction, or may be determined based on the tendency of the statistics registered in the text information dictionary 16. Alternatively, in a case where an anomaly sample is present in advance, the threshold may be determined based on the anomaly score related to the anomaly sample.

An example of a method for calculating the anomaly score is as follows. First, the anomaly detection unit 17 specifies, for each word or combination of words belonging to a specific part of speech included in the target text, a statistic associated with the word or the combination in the text information dictionary 16. Next, the anomaly detection unit 17 calculates a word anomaly score based on the specified statistic. Then, the anomaly detection unit 17 determines the target sample as anomaly in a case where the maximum value of the calculated word anomaly scores is larger than the threshold, and determines the target sample as normal in a case where the maximum value is smaller than the threshold.

As an example, the anomaly detection unit 17 calculates the anomaly score for each word using a word string included in the target text and the text information dictionary 16. The anomaly detection unit 17 checks whether or not each word included in the obtained word string is included in the text information dictionary 16. In a case where it is not included, the anomaly detection unit 17 sets the anomaly score of the word to 1. In a case where the word is included in the text information dictionary 16, the anomaly detection unit 17 acquires a probability of appearance p of the word and sets the anomaly score of the word to 1−p. After calculating the anomaly scores for all the words included in the word string, the anomaly detection unit 17 sets the maximum value of the anomaly scores as the anomaly score of the target sample.

In a case where the co-occurrence probability is stored in the text information dictionary 16, the anomaly detection unit 17 similarly calculates the anomaly score for a word pair in the target text. In a case where the conditional joint probability is stored in the text information dictionary 16, the anomaly detection unit 17 acquires the conditional joint probability p of the word pair stored in the text information dictionary 16 for the word pair included in the target text of the target sample, and sets the anomaly score of the corresponding word pair to 1−p.

The output unit 18 outputs a determination result of whether or not the target sample has an anomaly by the anomaly detection unit 17. The output destination of the determination result may be a display device provided in the anomaly detection apparatus 10 or a display device of a computer connected to the anomaly detection apparatus 10 via a network. The output destination of the determination result may also be a storage apparatus provided in the anomaly detection apparatus 10 or a storage apparatus of a computer connected to the anomaly detection apparatus 10 via a network.

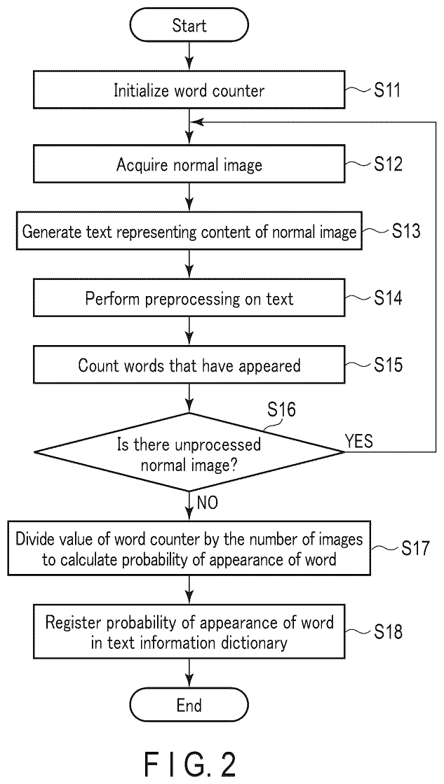

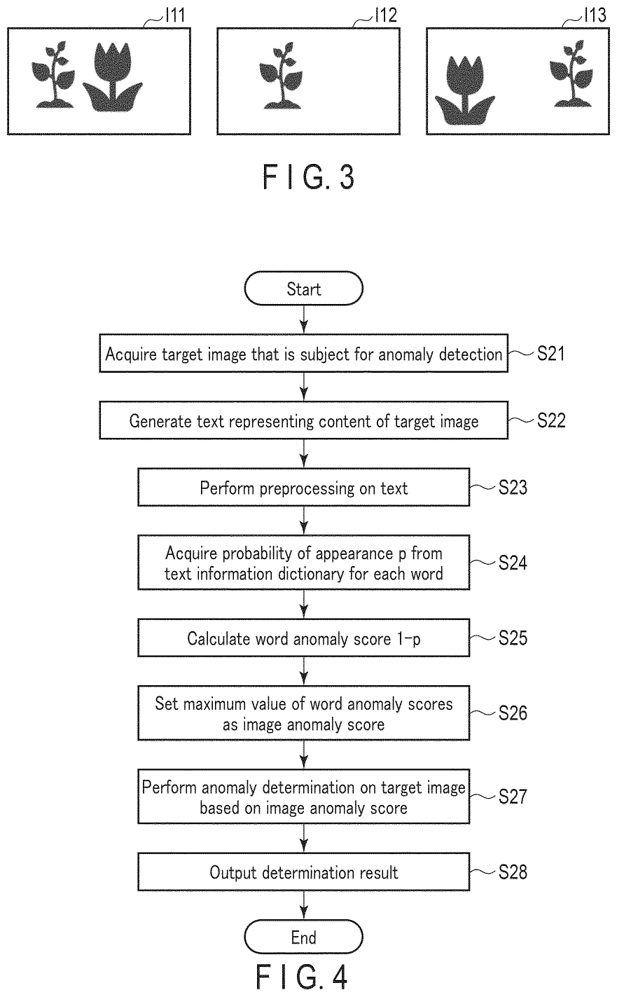

FIG. 2 is a diagram illustrating a flow of processing performed by the anomaly detection apparatus 10 according to the first embodiment at the time of training. In the following description, the sample is assumed to be an image. FIG. 3 is a diagram illustrating three normal images I11, I12, and I13 which are examples of the training data set according to the first embodiment.

First, the statistic calculation unit 14 initializes a word counter (step S11). The word counter is prepared for each word and is an object for counting the frequency of appearance of the word. In step S11, all the word counters are initialized to 0. The word counter may be prepared in advance, or may be generated in response to the detection of a new word in step S15.

After step S11 is performed, the acquisition unit 11 acquires a normal image from the training data set (step S12). In step S12, the normal images are acquired one by one. After step S12 is performed, the text generation unit 12 generates a text representing the content of the normal image based on the normal image acquired in step S12 (step S13). Specifically, the text generation unit 12 inputs the normal image to an image caption model, and generates a caption representing the content of the input normal image. The caption is an example of a text.

As an example, it is assumed that the normal image I11 in FIG. 3 is acquired in initial step S12. In the normal image I11, a flower and grass are shown. Therefore, for example, a caption of “There are a flower and grass.” is generated as the caption of the normal image I11.

After step S13 is performed, the preprocessing unit 13 performs preprocessing on the text generated in step S13 (step S14). Specifically, the preprocessing unit 13 performs word segmentation on the caption and extracts words belonging to a noun from the caption. In the case of the normal image I11 in FIG. 3, the caption is segmented into seven words (There, are, a, flower, and, grass,.) by word segmentation. Furthermore, preprocessing for extracting words belonging to a noun is performed to extract two words (flower, grass) from the above-described seven words.

After step S14 is performed, the statistic calculation unit 14 counts the words extracted in step S14 (step S15). In the case of the normal image I11 in FIG. 3, the statistic calculation unit 14 adds 1 to the values of the word counters for the two words (flower, grass). The value of the word counter has been initialized to 0, so that the value of the word counter of each of the word “flower” and the word “grass” is 1.

After step S15 is performed, the acquisition unit 11 determines whether or not there is an unprocessed normal image (step S16). In a case where it is determined that there is an unprocessed normal image (step S16: YES), steps S12 to S16 are repeated for the unprocessed normal image.

In the present embodiment, two normal images I12 and I13 illustrated in FIG. 3 remain, and thus, the processes of steps S12 to S15 are repeated for these normal images I12 and I13. For example, the caption of the normal image I12 that shows only grass is “There is grass.”. The caption of the normal image I13 that shows a flower and grass is “There are grass and a flower.”. At this point, 2 is set to the word counter of the word “flower”, and 3 is set to the word counter of the word “grass”.

In a case where it is determined that there is no unprocessed normal image (step S16: NO), the statistic calculation unit 14 divides the value of the word counter by the number of normal images included in the training data set to calculate the probability of appearance of the word (step S17). In the case of the example in FIG. 3, the number of normal images is three, and thus, the value of each word counter is divided by three. As a result, the probability of appearance of the word “flower” is 2/3, and the probability of appearance of the word “grass” is 1.

After step S17 is performed, the storage unit 15 registers the probability of appearance, calculated in step S17, of the word obtained in step S14 in the text information dictionary 16 (step S18). The text information dictionary 16 associates the word with the probability of appearance corresponding to the word. In the example in FIG. 3, data of (flower, 2/3) and (grass, 1) are registered in the text information dictionary 16.

Thus, the processing performed by the anomaly detection apparatus 10 according to the first embodiment at the time of training ends.

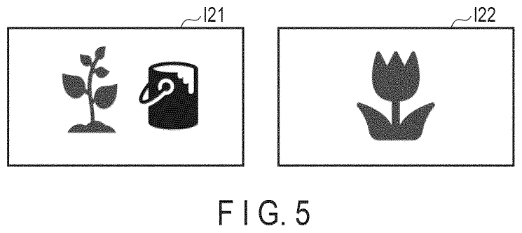

FIG. 4 is a diagram illustrating a flow of processing performed by the anomaly detection apparatus 10 according to the first embodiment at the time of anomaly detection. FIG. 5 is a diagram illustrating two target images I21 and I22 which are examples of the inference data set according to the first embodiment.

First, the acquisition unit 11 acquires a target image that is a subject for anomaly detection from the inference data set (step S21). In step S21, all the target images included in the inference data set may be acquired at a time, or only some of the target images may be acquired.

After step S21 is performed, the text generation unit 12 generates a text representing the content of the target image based on the target image acquired in step S21 (step S22). Specifically, the text generation unit 12 inputs the target image to the image caption model, and generates a caption representing the content of the input target image.

As an example, grass and a bucket are shown in the target image I21 in FIG. 5. Therefore, for example, a caption of “There are grass and a bucket.” is generated as the caption of the target image I21. In the target image I22 in FIG. 5, a flower is shown. Therefore, for example, a caption of “There is a flower.” is generated as the caption of the target image I22.

After step S22 is performed, the preprocessing unit 13 performs preprocessing on the caption generated in step S22 (step S23). Specifically, the preprocessing unit 13 performs word segmentation on the caption and extracts words belonging to a noun from the caption. In the case of the target image I21 in FIG. 5, the caption is segmented into seven words (There, are, grass, and, a, bucket,.). Furthermore, preprocessing for extracting words belonging to a noun is performed to extract two words (grass, bucket) from the above-described seven words. In the case of the normal image I22, the caption is segmented into five words (There, is, a, flower,.), and preprocessing of extracting words belonging to a noun is further performed, so that one word (flower) is extracted from the five words described above.

After step S23 is performed, the anomaly detection unit 17 acquires the probability of appearance p from the text information dictionary 16 for each word extracted in step S23 (step S24). In the case of the normal image I21 in FIG. 5, a value 1 is obtained as the probability of appearance for the word “grass” extracted in step S23. Here, the word “bucket” is not registered in the text information dictionary 16, and thus, the probability of appearance is set to a value 0. In the case of the normal image I22 in FIG. 5, a value 2/3 is obtained as the probability of appearance for the word “flower” extracted in step S23.

After step S24 is performed, the anomaly detection unit 17 calculates the word anomaly score 1−p based on the probability of appearance p acquired in step S24 (step S25). The word anomaly score indicates a degree to which the fact that the matter represented by the word appears in the target image is anomalous from the entire tendency of the plurality of normal images included in the training data set. The word anomaly score is calculated for each of one or more words related to one target image. Specifically, the anomaly detection unit 17 calculates the word anomaly score 1−p by subtracting the probability of appearance p from 1. In the case of the target image I21 in FIG. 5, the word anomaly score of the word “grass” is 0 (1−1=0), and the word anomaly score of the word “bucket” is 1 (1−0=1). In the case of the target image I22 in FIG. 5, the word anomaly score of the word “flower” is 1/3 (1−2/3=1/3).

After step S25 is performed, the anomaly detection unit 17 sets the maximum value among the one or more word anomaly scores calculated in step S25 as an image anomaly score (step S26). The image anomaly score indicates a degree to which the matter appearing in the target image is anomalous from the entire tendency of the plurality of normal images included in the training data set. Only one image anomaly score is calculated for one target image. In the case of the target image I21 in FIG. 5, the value of the word anomaly score of the word “bucket” is 1 which is the highest, and thus, the value of the image anomaly score of the target image I21 is set to 1. In the case of the target image I22 in FIG. 5, there is only the word “flower”, and thus, the value of the image anomaly score is set to 1/3 which is the word anomaly score of the word “flower”.

After step S26 is performed, the anomaly detection unit 17 performs anomaly determination on the target image based on the image anomaly score set in step S26 (step S27). Specifically, the anomaly detection unit 17 compares the image anomaly score with the threshold. In a case where the image anomaly score is greater than the threshold, the anomaly detection unit 17 determines the target image as anomaly, and in a case where the image anomaly score is smaller than the threshold, the anomaly detection unit 17 determines the target image as normal. In a case where the threshold is set to 0.5 for the target image I21 in FIG. 5, the image anomaly score is 1 which is larger than 0.5, and thus, the target image is determined as anomaly. In a case where the threshold is set to 0.5 for the target image I22 in FIG. 5, the image anomaly score is 1/3 which is smaller than 0.5, and thus, the target image is determined as normal.

After step S27 is performed, the output unit 18 outputs the determination result output in step S27 to the display device (step S28). As an example, the output unit 18 displays the target sample, the target text, and the determination result side by side on the display device. At this time, the output unit 18 may use different visual effects for displaying a specific word having an image anomaly score (the maximum value of the word anomaly score) in the target text between the case where the image anomaly score is greater than the threshold and the case where the image anomaly score is smaller than the threshold. Furthermore, the output unit 18 may display the image anomaly score side by side with the specific word.

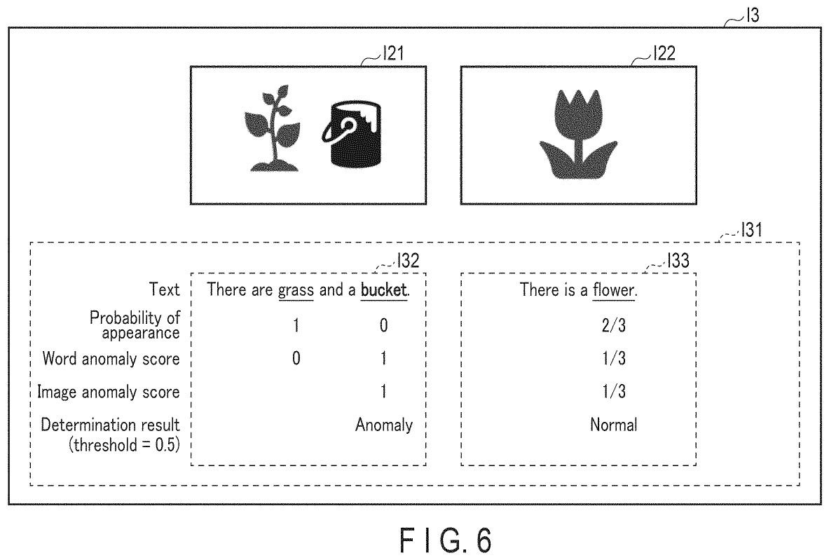

FIG. 6 is a diagram illustrating an example of a display screen 13 indicating the determination result of whether or not the target image has an anomaly. As an example, the display screen 13 illustrated in FIG. 6 indicates a determination result regarding the two target images I21 and I22 illustrated in FIG. 5. As illustrated in FIG. 6, the display screen 13 includes the target image I21, the target image I22, and a determination result display field I31. A determination result display field I32 related to the target image I21 and a determination result display field I33 related to the target image I22 are displayed as the determination result display field I31. For the target images I21 and I22, the target texts generated in step S22, the probabilities of appearance acquired in step S24, the word anomaly scores calculated in step S25, the image anomaly scores set in step S26, and the determination results output in step S27 are displayed in the determination result display fields I32 and I33, respectively.

In the target text, a word for which the probability of appearance and the word anomaly score are acquired may be emphasized with, for example, an underline or the like. Specifically, the word “grass” and the word “bucket” are emphasized with an underline for the target image I21, the word “flower” is emphasized with an underline for the target image I22, and conversely, the word “There”, the word “are”, and the like are not emphasized with an underline because they are not the subjects for which the probability of appearance and the word anomaly score are acquired. The probability of appearance, the word anomaly score, and the image anomaly score may be aligned and displayed below the corresponding word. As an example, for the word “grass”, the probability of appearance “1” and the word anomaly score “0” are displayed, and the image anomaly score is not displayed because it has not been acquired. For the word “bucket”, the probability of appearance “0”, the word anomaly score “1”, and the image anomaly score “1” are displayed. For the word “There”, the word “are”, and the like, the probability of appearance, the word anomaly score, and the image anomaly score are not the subjects to be acquired, and thus, none of them are displayed.

As the determination result, a character string of “normal” or “anomaly” is displayed. The threshold may be displayed beside the determination result. Different visual effects are used to display the word for which the image anomaly score is acquired between the case where the determination result indicates anomaly and the case where the determination result indicates normal. Specifically, since the target image I21 is determined as “anomaly”, the word “bucket” for which the image anomaly score is acquired is displayed in bold, and since the target image I22 is determined as “normal”, the word “flower” for which the image anomaly score is acquired is displayed in ordinary thickness.

As described above, by displaying the target image and the determination result side by side, the user can grasp each target image and the corresponding determination result in association with each other. As the basis of the determination result, the text, the probability of appearance, the word anomaly score, and the image anomaly score are displayed side by side, whereby the user can grasp on which part of the text the anomaly is determined, and can evaluate the accuracy of the determination result.

Note that the display screen of the determination result illustrated in FIG. 6 is merely an example, and the display content can be freely designed. For example, it is not necessary to display all of the text, the probability of appearance, the word anomaly score, and the image anomaly score, and the manner of display can be freely set according to the user or the like. In addition, the visual effect for emphasizing the word for which the probability of appearance and the word anomaly score are to be acquired relative to other words is not limited to underlining, and any visual effect such as display color or annotation can be employed. In addition, the visual effect that differs between the case of “anomaly” and the case of “normal” for the word for which the image anomaly score is acquired is not limited to changing the thickness of the character, and any visual effect such as changing a display color or annotation can be employed.

Thus, the processing performed by the anomaly detection apparatus 10 according to the first embodiment at the time of anomaly detection ends.

As described above, the anomaly detection apparatus 10 according to the first embodiment includes the acquisition unit 11, the text generation unit 12, the anomaly detection unit 17, and the output unit 18. The acquisition unit 11 acquires a target sample that is a subject for anomaly detection. The text generation unit 12 generates a target text representing the content of the target sample from the target sample using a trained model. The anomaly detection unit 17 determines whether or not the target sample has an anomaly based on the statistic associated with all or a part of the target text in the text information dictionary 16. The text information dictionary 16 associates all or a part of a training text representing the content of the training sample included in a training data set with a statistic related to the degree of appearance of all or a part of the training text in the training data set. The output unit 18 outputs a determination result of whether or not the target sample has an anomaly.

In typical unsupervised anomaly detection, a normal sample such as a normal image is converted into a feature value and stored as a feature value dictionary. In typical unsupervised anomaly detection, a sample that is a subject for anomaly detection is converted into a feature value, and in a case where the feature value is away from the tendency of a feature value group stored in the feature value dictionary, the sample is determined as anomaly. As described above, the typical unsupervised anomaly detection converts the sample into a feature value, and thus, in a case where an acquisition environment where the sample is acquired greatly varies, the difference in the acquisition environment is also reflected in the feature value. Therefore, it can be said that the typical unsupervised anomaly detection is vulnerable to a change in the acquisition environment.

On the other hand, the text generation unit 12 according to the present embodiment converts the target sample into the target text by the text generation model, and thus, it is possible to convert the content of the target sample into the target text that is character information which has a higher abstraction level and from which information unnecessary for anomaly detection is excluded. For example, in a case where the sample is an image and an imaging environment such as an angle of view of a camera or illumination varies, it is possible to convert the image into a text that is hardly affected by the imaging environment and that abstractly represents the main content of the image. Therefore, according to the present embodiment, it is possible to convert the content of the target sample into a target text in the form of character information that is hardly affected by a change in the acquisition environment. The same applies to the training sample. The text information dictionary 16 associates the training text representing the content of the training sample with the statistic of the degree of appearance of the training text. That is, even in a case where the acquisition environment where the training sample is acquired greatly varies, the text information dictionary 16 can store the contents of these training samples in a text format robust to a change in the acquisition environment. Then, since the anomaly detection unit 17 applies the text information dictionary 16 to the target text, it is possible to determine a target sample corresponding to a text deviating from the tendency of the training text stored in the text information dictionary 16 as anomaly. This enables robust anomaly detection against a change in the acquisition environment where the target sample is acquired.

### Second Embodiment

A text generation unit 12 according to the second embodiment uses, as a trained model, a text generation model using a prompt instead of the image caption generation model. The text generation model using a prompt uses a sample and a prompt as an input and outputs a text for the combination of the sample and the prompt. The prompt is a text indicating an instruction for the text generation model. Examples of the prompt include a question sentence for the content of the sample, a statement for a text generation model used to obtain a text (output of the text generation model), and other texts. In the following, it is assumed that the text generation model according to the second embodiment is a visual question answering model using a question sentence as a prompt. An anomaly detection apparatus according to the second embodiment will be described below. In the description of the present embodiment, the description of the same parts as those of the first embodiment will be omitted or simplified.

An acquisition unit 11 acquires a sample in the same manner as in the first embodiment and also acquires a prompt to be input to the visual questioning answering model. The prompt is obtained for each of a training sample and a target sample. The prompt means a question sentence for the content of the sample. For example, in a case where the sample is an image, examples of the prompt to be used include a sentence to inquire about an object in the image such as “What is the object in the image?”, a sentence to identify the position of interest or inquire about the state of the object such as “How is the state of the object at the center in the image?”, and a sentence to inquire about the number of objects in the image such as “How many components are shown in the image?”. The acquisition unit 11 may acquire a plurality of prompts. The same prompt may be used for all the samples. On the other hand, in a case where metadata or the like is attached to the sample, the prompt may be changed according to the metadata or the like.

A text generation unit 12 inputs the sample and the prompt acquired by the acquisition unit 11 to the visual question answering model, and generates an answer sentence to the prompt as a text. For example, in a case where an image showing grass and a prompt “What is the object shown in the image?” are input to the visual question answering model, an answer sentence such as “The grass is shown” or “grass” are output as a text. In a case where there are a plurality of prompts, the text generation unit 12 generates, for one sample, a plurality of answer sentences respectively corresponding to the plurality of prompts. In this case, the text generation unit 12 may output all of the plurality of answer sentences, or may select an answer sentence to be output from among the plurality of answer sentences based on an index such as the length of the sentence or the number of nouns, and output only the selected answer sentence. The answer sentence is obtained for each of the training sample and the target sample.

Processes performed by a preprocessing unit 13, a statistic calculation unit 14, a storage unit 15, an anomaly detection unit 17, and an output unit 18 are similar to those in the first embodiment, and thus the description thereof is omitted.

As described above, the anomaly detection apparatus 10 according to the second embodiment can manipulate the content of the text generated by the text generation unit 12 by using the prompt, whereby it is possible to detect an anomaly from a viewpoint that the user intends to focus more on as compared with the first embodiment. For example, in a case where a prompt “What is the object shown in the image?” is used, it is possible to detect an anomaly from the viewpoint of an object shown in an image.

### Third Embodiment

An anomaly detection apparatus according to the third embodiment converts a text representing the content of a sample into a feature value and determines whether or not the sample has an anomaly based on the feature value. The anomaly detection apparatus according to the third embodiment will be described below. In the description of the present embodiment, the description of parts similar to those of the first embodiment will be omitted or simplified.

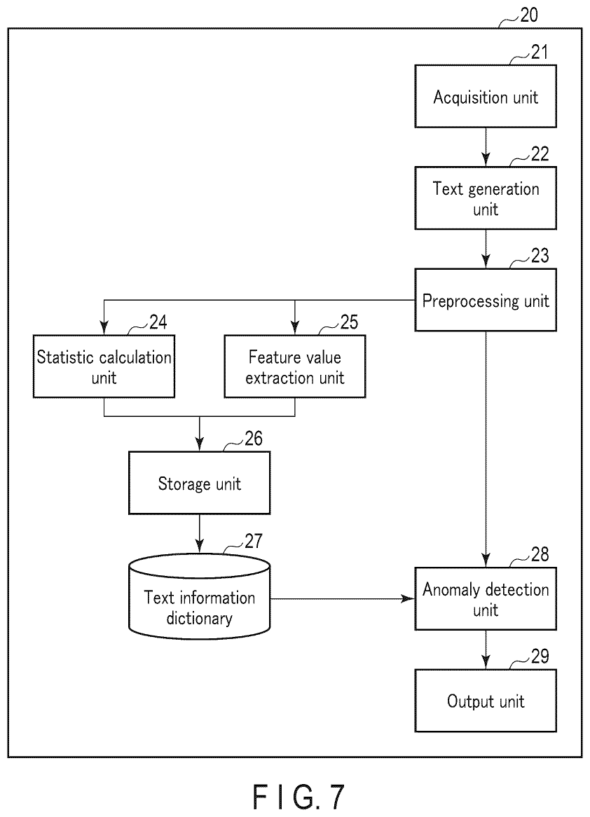

FIG. 7 is a functional block diagram illustrating an example of an anomaly detection apparatus 20 according to the third embodiment. As illustrated in FIG. 7, the anomaly detection apparatus 20 includes an acquisition unit 21, a text generation unit 22, a preprocessing unit 23, a statistic calculation unit 24, a feature value extraction unit 25, a storage unit 26, a text information dictionary 27, an anomaly detection unit 28, and an output unit 29. The acquisition unit 21, the text generation unit 22, the preprocessing unit 23, and the output unit 29 are substantially the same as the acquisition unit 11, the text generation unit 12, the preprocessing unit 13, and the output unit 18 according to the first embodiment, respectively.

The statistic calculation unit 24 calculates the frequency of appearance of all or a part of each of a plurality of training samples included in a training data set, and calculates a statistic based on the calculated frequency of appearance. In a case where “all or a part of the training text” is a word or a combination of words belonging to a specific part of speech, the statistic calculation unit 24 calculates, as a statistic, a probability of appearance based on the frequency of appearance of the word or the combination of words.

The feature value extraction unit 25 extracts a feature value from all or a part of the text indicating the content of the sample. The feature value is expressed in a format such as a scalar, a vector, or a tensor. In the following description, it is assumed that the feature value is a vector. The vectorized feature value is referred to as a feature vector. It is assumed that all or a part of the text is a word. As a means for extracting the feature value from all or a part of the text, a known method such as word2vec or ELMo disclosed in Non-Patent Literature 1 (Matthew E. Peters, Mark Neumann, Mohit Iyyer, Matt Gardner, Christopher Clark, Kenton Lee, Luke Zettlemoyer. Deep contextualized word representations. NAACL 2018) can be used. Furthermore, the feature value extraction unit 25 may extract the feature value from all or a part of the text using the trained model used in the text generation unit 22.

The storage unit 26 registers all or a part of the text, the statistic calculated by the statistic calculation unit 24, and the feature value extracted by the feature value extraction unit 25 in the text information dictionary 27 in association with each other, and stores the text information dictionary 27. For example, the text information dictionary 27 stores, using a word as a key, a pair of a probability of appearance and a feature vector of the word as a value.

Based on the statistic associated with all or a part of a target text and the feature value in the text information dictionary 27, the anomaly detection unit 28 calculates the word anomaly score of all or a part of the target text. The anomaly detection unit 28 determines the target sample as anomaly in a case where the maximum value (image anomaly score) of the calculated word anomaly scores is larger than a threshold, and determines the target sample as normal in a case where the image anomaly score is smaller than the threshold.

In a case where “all or a part of the training text” is a word or a combination of words belonging to a specific part of speech, the anomaly detection unit 28 calculates, based on the probability of appearance associated with a word or the combination of words belonging to the specific part of speech included in the target text and the feature value in the text information dictionary 27, the word anomaly score of the word or the combination. In a case where “all or a part of the training text” is a word belonging to a specific part of speech, the text information dictionary 27 uses the word as a key and stores a pair of a probability of appearance and a vectorized feature value of the word as a value. The anomaly detection unit 28 calculates a word anomaly score for a word belonging to a noun included in the caption of the target image by using the following Expression (2). Here, p(j) is the probability of appearance of a word j included in the text information dictionary 27, and d(xᵢ, xⱼ) is the Euclidean distance between the feature value vector of a word i and the feature vector of the word j.

$$AnomalyScore ( i ) = {\sum }_{j} - p ( j ) {e}^{- d ( {x}_{i} \cdot {x}_{j} )} \qquad ( 2 )$$

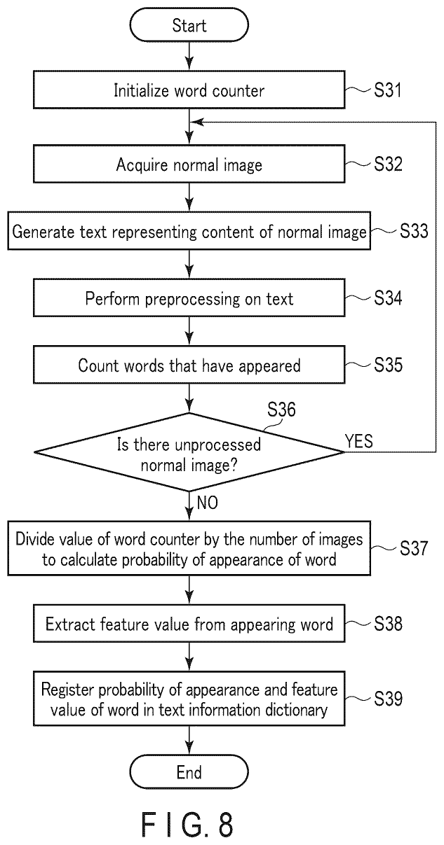

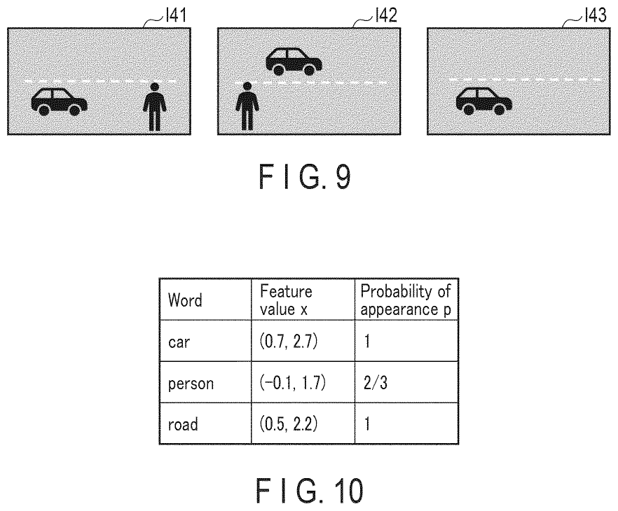

FIG. 8 is a diagram illustrating a flow of processing performed by the anomaly detection apparatus 20 according to the third embodiment at the time of training. In the following description, the sample is assumed to be an image. FIG. 9 is a diagram illustrating three normal images I41, I42, and I43 which are examples of a training data set according to the third embodiment.

Steps S31 to S37 illustrated in FIG. 8 are similar to steps S11 to S17 illustrated in FIG. 2. The normal image I41 illustrated in FIG. 9 shows a car, a person, and a road, and thus, the training text based on the normal image I41 includes the word “car”, the word “person”, and the word “road”. The normal image I42 shows a car, a person, and a road, and thus, the training text based on the normal image I42 includes the word “car”, the word “person”, and the word “road”. The normal image I43 shows a car and a road, and thus, the training text based on the normal image I43 includes the word “car” and the word “road”. Then, 1 is calculated as the probability of appearance of the word “car”, 2/3 as the probability of appearance of the word “person”, and 1 as the probability of appearance of the word “road”.

After step S37 is performed, the feature value extraction unit 25 extracts a feature value from each of all the words that have appeared in the training data set (step S38). As described above, a feature vector is calculated as the feature value. Examples of a specific method for calculating the feature vector based on the word include obtaining a high-dimensional vector using a machine learning model that converts the word into a vector, such as word2vec as described above. In the case of the normal images I41, I42, and I43 in FIG. 9, feature vectors are extracted for the word “car”, the word “person”, and the word “road”, respectively. Here, it is assumed that two-dimensional vectors of (0.7, 2.7) for the word “car”, (−0.1, 1.7) for the word “person”, and (0.5, 2.2) for the word “road” are calculated.

After step S38 is performed, the storage unit 26 registers the probability of appearance calculated in step S37 and the feature value extracted in step S38 regarding the word obtained in step S34 in the text information dictionary 27 (step S39).

FIG. 10 is a diagram illustrating an example of the text information dictionary 27 according to the third embodiment. As illustrated in FIG. 10, the text information dictionary 27 associates a word, a feature value x corresponding to the word, and a probability of appearance p corresponding to the word. For example, the word “car”, the feature value (0.7, 2.7), and the probability of appearance “1” are registered in the text information dictionary 27 in association with each other. As a result, it is possible to systematically store the feature value in the text information dictionary 27 in association with the word in a searchable manner together with the probability of appearance.

Thus, the processing performed by the anomaly detection apparatus 20 according to the third embodiment at the time of training ends.

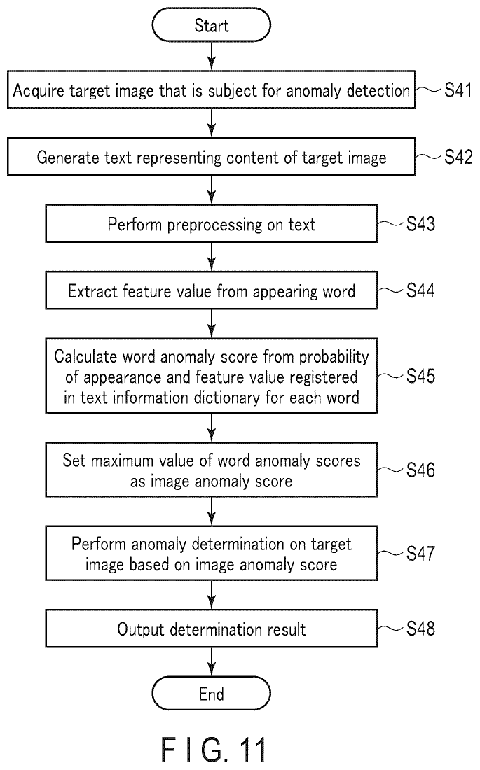

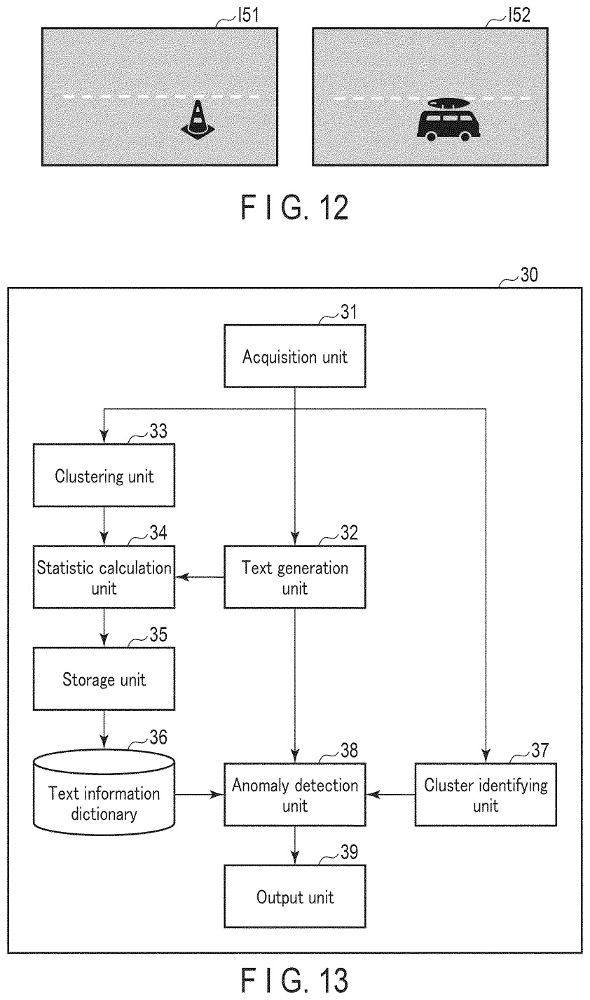

FIG. 11 is a diagram illustrating a flow of processing performed by the anomaly detection apparatus 20 according to the third embodiment at the time of anomaly detection. FIG. 12 is a diagram illustrating two target images I51 and I52 which are examples of an inference data set according to the third embodiment.

Steps S41 to S43 correspond to steps S21 to S23 in FIG. 4, and thus, the description thereof is omitted here. Note that, since the target image I51 in FIG. 12 shows a road and a cone, a text such as “There are a corn and a road.” is generated in step S42, and two words (corn, road) are extracted in step S43.

After step S43 is performed, the feature value extraction unit 25 extracts the feature value from each word extracted in step S43 (step S44). Specifically, the feature value extraction unit 25 converts each word into a feature vector using a machine learning model that converts a word into a vector, such as word2vec. The detail of the vectorization is similar to that at the time of training, and thus will be omitted. Note that, since the feature vector of the word “road” is calculated at the time of training, the result thereof is used. It is assumed that, as a result, (2.6, 0.8) is obtained as the feature vector of the word “corn”.

After step S44 is performed, the anomaly detection unit 28 calculates a word anomaly score for each word from the probability of appearance and the feature value registered in the text information dictionary 27 (step S45). Specifically, the anomaly detection unit 28 searches the text information dictionary 27 using the word as a key to read the probability of appearance and the feature vector, and calculates the word anomaly score based on the read probability of appearance and feature vector. The word anomaly score is calculated based on Expression (2) described above. As an example, the calculation expression for the word anomaly score “Anomaly Score (corn)” of the word “corn” is represented by Expression (3) described below. As a result, the word anomaly score “Anomaly Score (corn)” is −0.19. Similarly, the word anomaly score is calculated for the word “road”. The word anomaly score “Anomaly Score (road)” is −1.89. The word anomaly score indicates that the smaller the value is, the more normal the word is.

$$AnomalyScore ( corn ) \\ \begin{matrix}= {\sum }_{j} - p ( j ) {e}^{- d ( {x}_{i} , {x}_{j} )} \\ = - p ( car ) {e}^{- d ( {x}_{corn} {x}_{car} )} - p ( person ) {e}^{- d ( {x}_{corn} {x}_{person} )} - p ( road ) {e}^{- d ( {x}_{corn} {x}_{road} )} \\ ≅ - 1 {e}^{- 2.7} - 0.67 {e}^{- 2.3} - 1 {e}^{- 2.5} \\ ≅ - 0.19\end{matrix} \qquad ( 3 )$$

Steps S46 to S48 are similar to steps S26 to S28 in FIG. 4, and thus the description thereof is omitted. The cone is shown in the target image I51 and there is no normal image in which the cone is shown in the training data set. Therefore, in a case where the threshold for the word anomaly score is set to, for example, −1.0, the image anomaly score −0.19 of the target image I51 is greater than the threshold, and thus, the target image I51 is determined as anomaly as expected.

Next, processing for the target image I52 in FIG. 12 will be described. The target image I52 shows a road and a van. Therefore, a text such as “There are a van and a road.” is generated in step S42, and two words (van, road) are extracted in step S43. In step S44, it is assumed that the word “van” is converted into a feature vector (0.8, 3.0). Here, since both the van and the car belong to vehicles, the feature vector of the word “van” is expected to be a feature vector similar to the feature vector of the word “car”. Actually, as illustrated in FIG. 10, the feature vector of the word “car” is (0.7, 2.7) which is similar to the feature vector (0.8, 3.0) of the word “van”.

In step S45, the word anomaly score “van” is calculated in the same manner as in the example of the word “corn”. The word anomaly score “Anomaly Score (van)” of the word “van” is represented by Expression (4) described below. The word anomaly score “Anomaly Score (van)” is −1.29.

$$AnomalyScore ( van ) \\ \begin{matrix}= {\sum }_{j} - p ( j ) {e}^{- d ( {x}_{i} , {x}_{j} )} \\ = - p ( car ) {e}^{- d ( {x}_{van} {x}_{car} )} - p ( person ) {e}^{- d ( {x}_{van} {x}_{person} )} - p ( road ) {e}^{- d ( {x}_{van} {x}_{road} )} \\ ≅ - 1 {e}^{- 0.1} - 0.67 {e}^{- 2.5} - 1 {e}^{- 0.7} \\ ≅ - 1.29\end{matrix} \qquad ( 4 )$$

Although the word “van” does not appear in the caption of the training data set and is not registered in the text information dictionary 27, the word anomaly score of the word “van” has a relatively small value, because the word “car” having a similar feature vector appears at the time of training. Therefore, in a case where the threshold for the word anomaly score is set to, for example, −1.0 for the target image I52, the image anomaly score −1.29 of the word “van” is smaller than the threshold, and thus, the target image I52 is determined as normal as expected, although there is no normal image showing a van in the training data set.

The third embodiment enables anomaly detection in consideration of a relationship between conceptually similar words such as the word “van” and the word “car”.

### Fourth Embodiment

An anomaly detection apparatus according to the fourth embodiment clusters samples, and creates and refers to different text information dictionaries for the clusters. The anomaly detection apparatus according to the fourth embodiment will be described below. In the description of the present embodiment, the description of parts similar to those of the first embodiment will be omitted or simplified.

FIG. 13 is a functional block diagram illustrating an example of an anomaly detection apparatus 30 according to the fourth embodiment. As illustrated in FIG. 13, the anomaly detection apparatus 30 includes an acquisition unit 31, a text generation unit 32, a clustering unit 33, a statistic calculation unit 34, a storage unit 35, a text information dictionary 36, a cluster identifying unit 37, an anomaly detection unit 38, and an output unit 39. The acquisition unit 31, the text generation unit 32, and the output unit 39 are substantially the same as the acquisition unit 11, the text generation unit 12, and the output unit 18 according to the first embodiment, respectively.

The clustering unit 33 clusters a training data set and divides a plurality of training samples into a plurality of clusters. The clustering unit 33 performs clustering by using an unsupervised clustering method. The number of clusters may be manually determined by a user, or may be automatically determined by using some index. The clustering unit 33 can extract a feature value from the training data set by a convolutional neural network or the like and divide a plurality of training samples into a plurality of clusters using a clustering method such as K-Means using the feature value. An identifier (hereinafter referred to as cluster ID) of a cluster to which each training sample belongs is allocated. Clustering makes it possible, for example, to allocate the training samples acquired in acquisition environments close to each other to the same cluster and allocate the training samples acquired in acquisition environments far away from each other to different clusters.

The statistic calculation unit 34 calculates, for each of the plurality of clusters, a statistic of the training text representing the content of the training sample belonging to the cluster.

The storage unit 35 associates all or a part of the training text with the statistic calculated by the statistic calculation unit 34 for the cluster ID allocated to each sample by the clustering unit 33. In other words, in a case where the number of clusters is k, k text information dictionaries 36 are created.

At the time of anomaly detection, the cluster identifying unit 37 identifies a cluster to which the target sample belongs from among a plurality of clusters. Specifically, the cluster identifying unit 37 infers the cluster ID of the target sample. The cluster IDs that can be inferred are limited to the cluster IDs of clusters that can be clustered by the clustering unit 33.

The anomaly detection unit 38 determines whether or not the target sample has an anomaly based on the statistic associated with the identifier of the cluster to which the target sample belongs in the text information dictionary 36. Specifically, the anomaly detection unit 38 reads the text information dictionary 36 related to the cluster ID of the target sample, and calculates the anomaly score of the target text based on the statistic associated with all or a part of the target text in the read text information dictionary 36. Then, the anomaly detection unit 38 determines the target sample as anomaly in a case where the anomaly score is larger than a threshold, and determines the target sample as normal in a case where the anomaly score is smaller than the threshold.

Note that instead of the clustering based on the feature value as described above, clustering based on metadata such as camera-position information may be performed. Specifically, the acquisition unit 31 acquires, for each of the training sample and the target sample, metadata such as camera-position information regarding the position of a camera that has imaged the sample. The clustering unit 33 divides the plurality of training samples into a plurality of clusters based on the metadata of the training samples. The cluster identifying unit 37 identifies a cluster to which the target sample belongs from among a plurality of clusters based on the metadata of the target sample. Using the metadata makes it possible to allocate the training samples having camera-position information close to each other to the same cluster and allocate the training samples having camera-position information far away from each other to different clusters.

According to the fourth embodiment, it is possible to limit the statistic to be searched associated with the target text to the statistics of the training texts belonging to the same cluster. That is, it is possible to narrow down the statistics to be searched associated with the target text to the statistic of the training text corresponding to the training sample acquired in the acquisition environment close to that of the target text to some extent. Therefore, it can be expected that the accuracy of anomaly detection is improved.

### Fifth Embodiment

An anomaly detection apparatus according to the fifth embodiment trains a text generation model used in a text generation unit. The anomaly detection apparatus according to the fifth embodiment will be described below. In the description of the present embodiment, the description of parts similar to those of the first embodiment will be omitted or simplified.

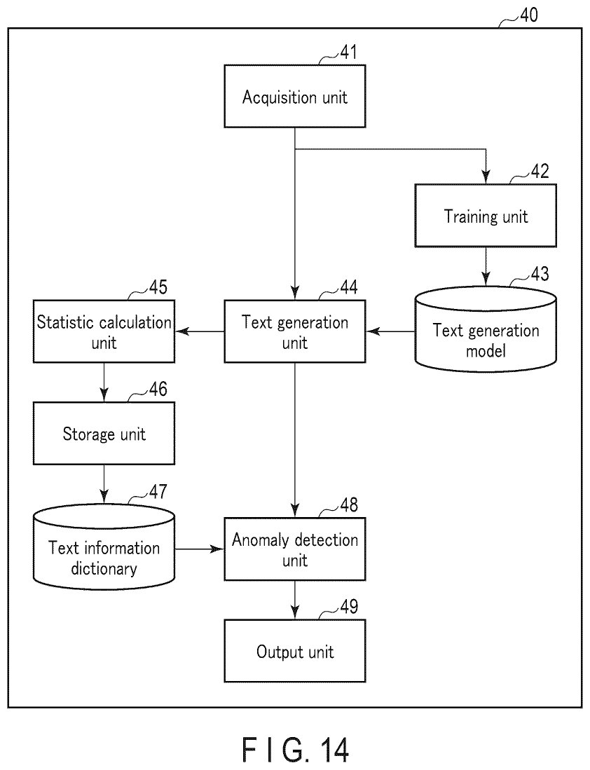

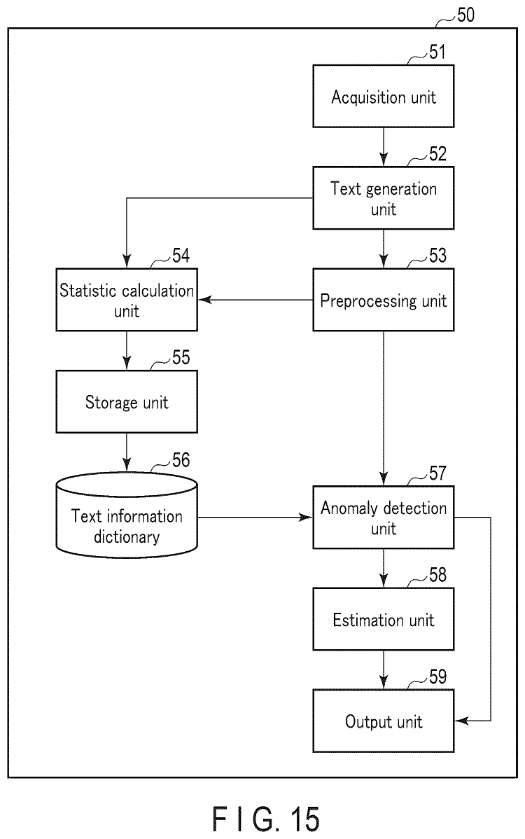

FIG. 14 is a functional block diagram illustrating an example of an anomaly detection apparatus 40 according to the fifth embodiment. As illustrated in FIG. 14, the anomaly detection apparatus 40 includes an acquisition unit 41, a training unit 42, a text generation model 43, a text generation unit 44, a statistic calculation unit 45, a storage unit 46, a text information dictionary 47, an anomaly detection unit 48, and an output unit 49. The text generation unit 44, the statistic calculation unit 45, the storage unit 46, the anomaly detection unit 48, and the output unit 49 are substantially the same as the text generation unit 12, the statistic calculation unit 14, the storage unit 15, the anomaly detection unit 17, and the output unit 18 according to the first embodiment, respectively.

The acquisition unit 41 outputs a pair of a sample and a text indicating the content of the sample. As the text, a text corresponding to an anomaly to be detected is prepared. As an example, in a case where it is desired to detect a fallen bicycle as an anomaly but the text generation unit 44 does not distinguish between a fallen bicycle and a bicycle that is standing and outputs only the word “bicycle”, a training sample of the fallen bicycle and a text including a phrase “fallen bicycle” are prepared. By performing training with such a text, the text generation unit 44 can output a text that can distinguish between a fallen bicycle and a bicycle that is standing, and it is considered that anomaly detection is possible even in such a situation. Furthermore, as the text, a text that does not include information unnecessary for anomaly detection may be prepared. For example, a text from which a word related to the weather such as “sunny” or an abstract word such as “beautiful” is removed may be prepared.

Based on the sample and the text output by the acquisition unit 41, the training unit 42 trains an untrained model so as to input the sample and output a text representing the content of the sample, and generates the text generation model 43. The untrained model may be already trained based on some data set, and the text generation model 43 may be generated by fine-tuning the untrained model. The text generation model 43 is used by the text generation unit 44.

According to the fifth embodiment, the text generation model 43 is generated using a text capable of distinguishing an anomaly to be detected, whereby it is possible to control the tendency of the text generated by the text generation unit 44 and to generate a training text and a target text suitable for the anomaly to be detected. For example, in a case where it is desired to detect a fallen bicycle as an anomaly, the acquisition unit 41 acquires a sample and a text “fallen bicycle” of the fallen bicycle and a sample and a text “bicycle that is standing” of the bicycle that is standing, and the training unit 42 generates the text generation model 43 using these samples and texts. By using the text generation model 43 generated in this way, the text generation unit 44 can generate a training text and a target text in which the fallen bicycle and the bicycle that is standing are distinguished. Therefore, for example, it is possible to determine a target sample including a fallen bicycle as anomaly or determine a target sample including a bicycle that is standing as normal.

### Sixth Embodiment

An anomaly detection apparatus according to the sixth embodiment estimates an anomaly point in a target sample, in a case where the target sample is determined as anomaly. The anomaly detection apparatus according to the sixth embodiment will be described below. It is assumed that a sample according to the sixth embodiment is an image. In the description of the present embodiment, the description of parts similar to those of the first embodiment will be omitted or simplified.

FIG. 15 is a functional block diagram illustrating an example of an anomaly detection apparatus 50 according to the sixth embodiment. The anomaly detection apparatus 50 includes an acquisition unit 51, a text generation unit 52, a preprocessing unit 53, a statistic calculation unit 54, a storage unit 55, a text information dictionary 56, an anomaly detection unit 57, an estimation unit 58, and an output unit 59. The acquisition unit 51, the text generation unit 52, the preprocessing unit 53, the statistic calculation unit 54, the storage unit 55, and the anomaly detection unit 57 are substantially the same as the acquisition unit 11, the text generation unit 12, the preprocessing unit 13, the statistic calculation unit 14, the storage unit 15, and the anomaly detection unit 17 according to the first embodiment, respectively.

The estimation unit 58 estimates an image region (hereinafter, referred to as anomaly region) corresponding to a word (hereinafter, referred to as anomaly word) in which the statistic indicates an anomaly in the target image. The target image in which the anomaly region is emphasized is referred to as an anomaly-point emphasis image. Specifically, the estimation unit 58 specifies an anomaly word by applying a threshold to the word anomaly score calculated by the anomaly detection unit 57. Next, the estimation unit 58 specifies an anomaly region corresponding to the anomaly word. As an example, the estimation unit 58 estimates the anomaly region based on gradient information regarding the anomaly word of the text generation model. Specifically, it is possible to use a method for specifying the region of interest using a gradient such as Guided Back Propagation. As another example, the estimation unit 58 may estimate the anomaly region by performing object detection with the anomaly word as a prompt. Specifically, it is possible to use zero-shot object detection such as Grounding DINO described in Non-Patent Literature 2 (Shilong Liu, Zhaoyang Zeng, Tianhe Ren, Feng Li, Hao Zhang, Jie Yang, Chunyuan Li, Jianwei Yang, Hang Su, Jun Zhu, Lei Zhang. Grounding DINO: Marrying DINO with Grounded Pre-Training for Open-Set Object Detection. arXiv: 2303.05499).

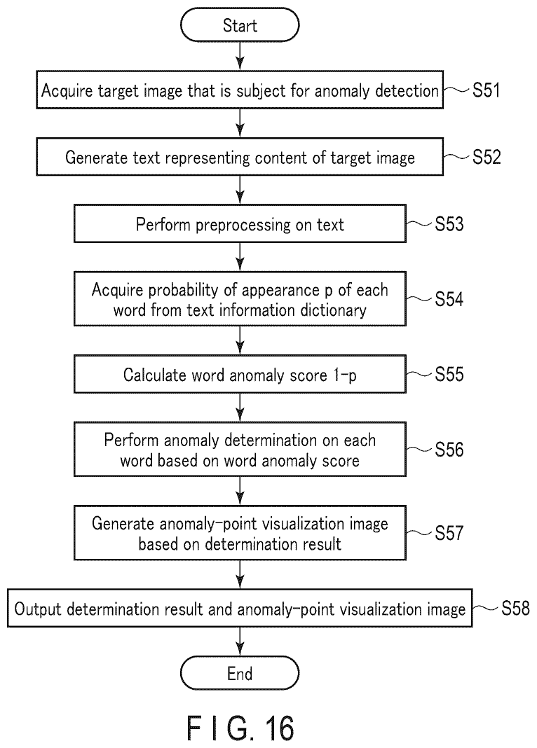

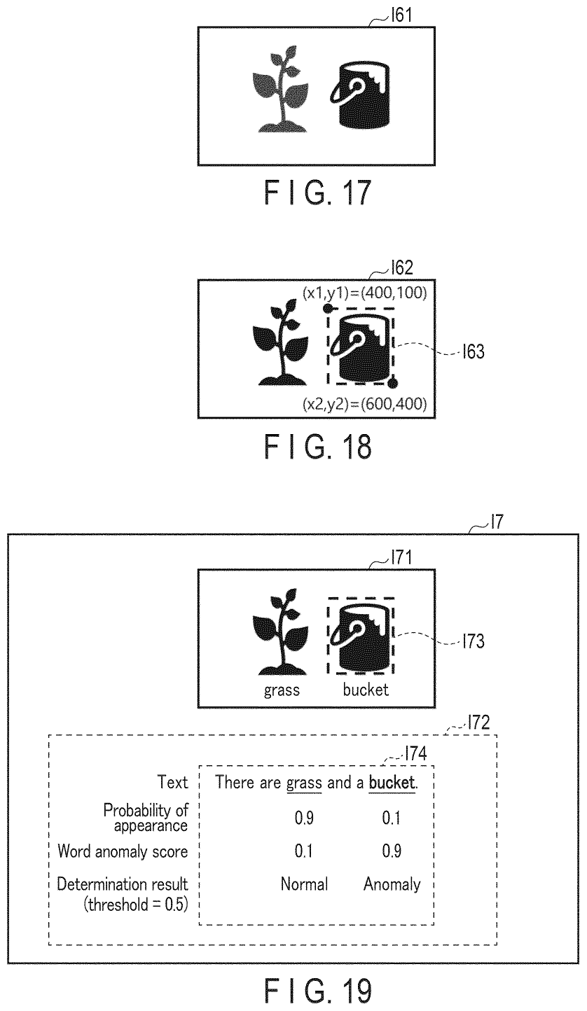

FIG. 16 is a diagram illustrating a flow of processing performed by the anomaly detection apparatus 50 according to the sixth embodiment at the time of anomaly detection. Note that the flow of processing performed by the anomaly detection apparatus 50 according to the sixth embodiment at the time of training is similar to that of the first embodiment, and thus will be omitted. FIG. 17 is a diagram illustrating one target image I61 which is an example of an inference data set according to the sixth embodiment.

Steps S51 to S55 illustrated in FIG. 16 are similar to steps S21 to S25 illustrated in FIG. 4. The target image I61 illustrated in FIG. 17 shows grass and a bucket that is an anomaly object, and a target text based on the target image I61 includes the word “grass” and the word “bucket”. Then, in step S55, the word anomaly score of the word “grass” and the word anomaly score of the word “bucket” are calculated. It is assumed that the word anomaly score of the word “grass” is 0.1 and the word anomaly score of the word “bucket” is 0.9.

After step S55 is performed, the estimation unit 58 performs anomaly determination for each word based on the word anomaly score calculated in step S55 (step S56). Specifically, the estimation unit 58 determines, for each word, whether or not the word is anomalous by applying a preset threshold to the word anomaly score. In a case where the anomaly score is larger than the threshold, the estimation unit 58 determines the word as anomaly, and in a case where the anomaly score is smaller than the threshold, the estimation unit 58 determines the word as normal. In this example, the threshold is set to 0.5. The word “grass” has a word anomaly score of 0.1 which is smaller than the threshold, and thus is determined as normal. The word “bucket” has a word anomaly score of 0.9 which is greater than the threshold, and thus is determined as anomaly.

After step S56 is performed, the estimation unit 58 generates an anomaly-point visualization image based on the determination result of step S56 (step S57). Specifically, the estimation unit 58 performs zero-shot object detection using the word (anomaly word) determined as anomaly in step S56. Here, it is assumed that the Grounding DINO described in Non-Patent Literature 2 is used. The estimation unit 58 detects an image region (anomaly region) corresponding to the anomaly word by performing zero-shot object detection with the anomaly word as a prompt, and outputs a target image including a rectangle enclosing the detected anomaly region as an anomaly-point visualization image. The anomaly-point visualization image is an example of the anomaly-point emphasis image because the anomaly region is emphasized with a rectangle.

FIG. 18 is a diagram illustrating an example of a result of the zero-shot object detection, and is a diagram illustrating an anomaly-point visualization image I62 that includes a rectangle I63 enclosing an anomaly region. The anomaly-point visualization image I62 is based on the target image I61 illustrated in FIG. 17. The estimation unit 58 detects a set of pixels constituting a bucket corresponding to the word “bucket” as an anomaly region by performing zero-shot object detection with the anomaly word “bucket” as a prompt. The estimation unit 58 draws a rectangle I63 enclosing the anomaly region on the target image I61. In FIG. 18, x1 and y1 represent the x coordinate and the y coordinate of the upper left point of the rectangle I63, respectively, and x2 and y2 represent the x coordinate and the y coordinate of the lower right point of the rectangle I63, respectively. By drawing the rectangle I63 on the target image I61, the anomaly-point visualization image I62 is generated.

After step S57 is performed, the output unit 59 outputs the determination result for each word indicating whether or not the word is anomalous output in step S56 and the anomaly-point visualization image generated in step S57 (step S58). As an example, the output unit 59 outputs a display screen including the determination result for each word indicating whether or not the word is anomalous and the anomaly-point visualization image to a display device.

FIG. 19 is a diagram illustrating a display screen I7 including a display field I72 of the determination result for each word indicating whether or not the word is anomalous and the anomaly-point visualization image I71. As illustrated in FIG. 19, the anomaly-point visualization image I71 and the determination result I72 are displayed on the display screen 17. The anomaly-point visualization image I71 illustrated in FIG. 19 is based on the target image I61 illustrated in FIG. 17. As illustrated in FIG. 19, grass and a bucket are shown in the anomaly-point visualization image I71. As described above, the bucket is detected as an anomaly region, so that the rectangle 173 enclosing the bucket is drawn.

A determination result 174 output in step S56 and indicating, for each word, whether or not the word is anomalous is displayed in the display field I72. For the target image I61, the determination result 174 displays the text generated in step S52, the probability of appearance acquired in step S54, the word anomaly score calculated in step S55, and the determination result output in step S56. The threshold such as “0.5” may be displayed side by side with the determination result.

In the text, a word for which the probability of appearance and the word anomaly score are acquired may be emphasized with, for example, an underline or the like. Specifically, the word “grass” and the word “bucket” are emphasized with an underline for the target image I61, and conversely, the word “There”, the word “are”, and the like are not emphasized with an underline because they are not the subjects for which the probability of appearance and the word anomaly score are acquired. The probability of appearance, the word anomaly score, and the determination result may be aligned and displayed below the corresponding word. As an example, the probability of appearance “0.9”, the word anomaly score “0.1”, and the determination result “normal” are displayed for the word “grass”, and the probability of appearance “0.1”, the word anomaly score “0.9”, and the determination result “anomaly” are displayed for the word “bucket”. For the word “There”, the word “are”, and the like, the probability of appearance, the word anomaly score, and the determination result are not the subjects to be acquired, and thus, none of them are displayed.

Note that the word corresponding to the object shown in the anomaly-point visualization image I71 may be displayed side by side with the object. Specifically, the word “bucket” may be displayed below the bucket. As a result, a user can easily grasp the correspondence between the word displayed in the text and the object shown in the anomaly-point visualization image I71. Note that the output unit 59 may output an anomaly scoring map instead of or in parallel with the anomaly-point visualization image. The anomaly scoring map can be generated by the estimation unit 58. Specifically, the estimation unit 58 calculates, for each pixel, an anomaly scoring indicating a probability of being an image region (anomaly region) corresponding to an anomaly word, and allocates luminance corresponding to the calculated anomaly scoring to the pixel, thereby generating a grayscale image. The output unit 59 outputs the generated grayscale image as an anomaly scoring map. For example, the output unit 59 may display the anomaly scoring map instead of or together with the anomaly-point visualization image I71 illustrated in FIG. 19. In the anomaly scoring map, the anomaly region is displayed with high luminance and the other regions are displayed with low luminance. Therefore, the anomaly scoring map is an image in which the anomaly region is emphasized. The anomaly scoring map is an example of an anomaly-point emphasis image.

Thus, the processing performed by the anomaly detection apparatus 50 according to the sixth embodiment at the time of anomaly detection ends.

As described above, by displaying the anomaly-point emphasis image in which the anomaly region corresponding to the anomaly word is emphasized with a rectangle, the user can clearly grasp which part in the image is determined as anomaly. In addition, by displaying the anomaly-point emphasis image and the determination result side by side, the user can grasp the anomaly-point emphasis image and the determination result in association with each other. As the basis of the determination result, the text, the probability of appearance, the word anomaly score, and the determination result are displayed side by side, whereby the user can grasp on which part of the text the determination for anomaly or normal is performed, and can evaluate the accuracy of the determination result.

### Seventh Embodiment

An anomaly detection apparatus according to the seventh embodiment edits a text information dictionary. The anomaly detection apparatus according to the seventh embodiment will be described below. In the description of the present embodiment, the description of the same parts as those of the first embodiment will be omitted or simplified.

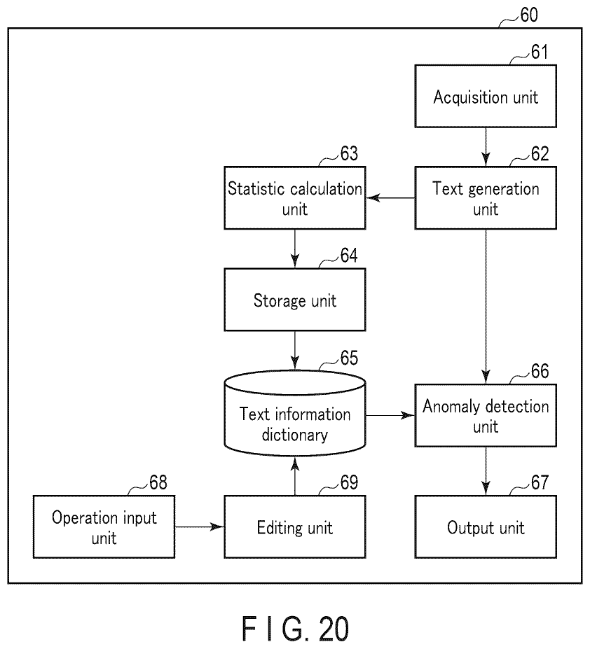

FIG. 20 is a functional block diagram illustrating an example of an anomaly detection apparatus 60 according to the seventh embodiment. As illustrated in FIG. 20, the anomaly detection apparatus 60 includes an acquisition unit 61, a text generation unit 62, a statistic calculation unit 63, a storage unit 64, a text information dictionary 65, an anomaly detection unit 66, an output unit 67, an operation input unit 68, and an editing unit 69. The acquisition unit 61, the text generation unit 62, the statistic calculation unit 63, the storage unit 64, the anomaly detection unit 66, and the output unit 67 are substantially the same as the acquisition unit 11, the text generation unit 12, the statistic calculation unit 14, the storage unit 15, the anomaly detection unit 17, and the output unit 18 according to the first embodiment, respectively.

The operation input unit 68 inputs a text and/or information regarding a statistic of the text according to a user's instruction. Specifically, the operation input unit 68 inputs a text to be added, deleted, or changed and a probability of appearance to the text information dictionary 65. As an example, in a case where the word “dog” that is originally normal at the time of initial anomaly detection is inferred as anomaly, information (dog, p=1.0) is input in order to give information indicating that the word “dog” will appear with high probability in the text information dictionary 65 for reducing erroneous detection. As another example, in a case where it is desired to detect an object such as a “kitchen knife” as anomaly, information (kitchen knife, p=0.0) is input. In addition, in a case where it is desired to delete a certain word from the text information dictionary, information such as (kitchen knife, p=“delete”) is input.

The editing unit 69 edits the text information dictionary 65 based on the information input with the operation input unit 68. Specifically, the editing unit 69 stores a pair of the text input with the operation input unit 68 and the probability of appearance in the text information dictionary 65. In addition, in a case where (kitchen knife, p=0.0) is input with the operation input unit 68 and information such as (kitchen knife, p=0.3) has already been registered in the text information dictionary 65, the editing unit 69 may overwrite the already registered information. In a case where (kitchen knife, p=“delete”) is input, the editing unit 69 deletes the kitchen knife and its probability of appearance from the text information dictionary 65. The subsequent anomaly detection is performed according to the edited text information dictionary 65.

According to the seventh embodiment, the text information dictionary 65 can be edited so that a user who has confirmed the determination result of whether or not an anomaly occurs does not detect a certain object or detects a certain object.

### Eighth Embodiment

An anomaly detection apparatus according to the eighth embodiment calculates a word anomaly score (object appearance anomaly score) and an object disappearance anomaly score by an anomaly detection unit, calculates an image anomaly score based on the object appearance anomaly score and the object disappearance anomaly score, and determines whether or not a target image has an anomaly based on the image anomaly score. The anomaly detection apparatus according to the eighth embodiment will be described below. In the description of the present embodiment, the description of parts similar to those of the first embodiment will be omitted or simplified.

The anomaly detection unit 17 calculates an object appearance anomaly score based on a probability of appearance associated with a word or a combination of words belonging to a specific part of speech included in the target text in the text information dictionary 16, calculates an object disappearance anomaly score based on a probability of appearance associated with a word not included in the target text among words or combinations of words stored in the text information dictionary 16, and determines whether or not the target sample has an anomaly based on the object appearance anomaly score and the object disappearance anomaly score.

Specifically, the anomaly detection unit 17 calculates the word anomaly score of each word included in the target text by referring to the text information dictionary 16, and specifies the maximum value thereof, as in the first embodiment. The maximum value is set as the object appearance anomaly score. Further, the anomaly detection unit 17 extracts a word not included in the target text among words in the text information dictionary 16, and specifies a word having the highest probability of appearance among the extracted words as a word corresponding to a missing object (hereinafter referred to as missing-object word). The missing object is an object that appears with a high probability in the training data set but does not appear in the target image. That is, it is highly likely that the matter in which the missing object does not appear in the target image is anomalous. Further, the anomaly detection unit 17 specifies the probability of appearance of the missing-object word in the text information dictionary 16 as the object disappearance anomaly score. As another example, the anomaly detection unit 17 may calculate a function value obtained by applying the probability of appearance of the missing-object word in the text information dictionary to any function as the object disappearance anomaly score. Examples of the function include a function that causes an output to be zero in a case where the value falls below any threshold, an exponential function, and the like. Then, the anomaly detection unit 17 calculates an image anomaly score by performing a weighted average of the object appearance anomaly score and the object disappearance anomaly score with any parameter.

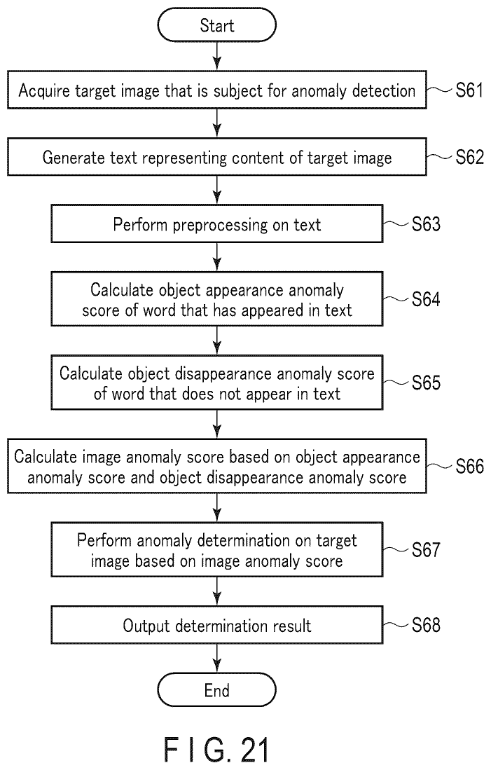

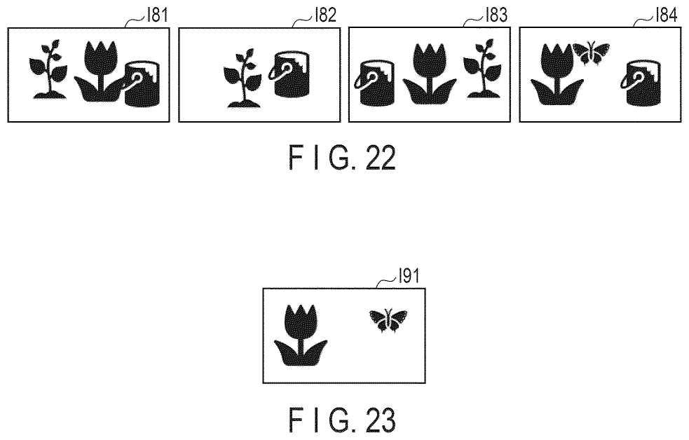

FIG. 21 is a diagram illustrating a flow of processing performed by the anomaly detection apparatus 10 according to the eighth embodiment at the time of anomaly detection. FIG. 22 is a diagram illustrating four normal images I81 to I84 which are examples of a training data set according to the eighth embodiment. The flow of processing performed by the anomaly detection apparatus 10 according to the eighth embodiment at the time of training is similar to that of the first embodiment, and thus will be omitted. As a result of training based on the training data set illustrated in FIG. 22, the probability of appearance of the word “bucket” is 1, the probability of appearance of the word “flower” is 3/4, the probability of appearance of the word “grass” is 3/4, and the probability of appearance of the word “butterfly” is 1/4. FIG. 23 is a diagram illustrating a target image I91 included in an inference data set. A flower and a butterfly are shown in the target image I91, but a bucket, which is an object shown in all of the four normal images I81 to I84, is not shown. Since no bucket is shown in the target image I91, it is expected that the target image I91 is determined as anomaly.

Steps S61 to S63 illustrated in FIG. 21 are similar to steps S21 to S23 illustrated in FIG. 4. The target text indicating the content of the target image includes a word “flower” and a word “butterfly”.

After step S63 is performed, the anomaly detection unit 17 calculates an object appearance anomaly score for the word that appears in the target text (step S64). Specifically, the anomaly detection unit 17 refers to the text information dictionary 16 to specify the word anomaly score for the word that appears in the target text as in the first embodiment, and sets the maximum value of the specified word anomaly scores is set as the object appearance anomaly score. In the case of the target image I91 in FIG. 23, the word anomaly score of the word “flower” is 0, and the word anomaly score of the word “butterfly” is 3/4. The maximum value of the word anomaly scores is 3/4, and thus, the object appearance anomaly score is 3/4.

After step S64 is performed, the anomaly detection unit 17 calculates an object disappearance anomaly score for the word that does not appear in the target text (step S65). Specifically, the anomaly detection unit 17 extracts a word (missing-object word) that is registered in the text information dictionary 16 but does not appear in the target text. In the case of the target image I91, the word “bucket” and the word “grass” correspond to the missing-object word. The probabilities of appearance stored in the text information dictionary 16 of the word “bucket” and the word “grass” are 1 and 3/4, respectively, and 1 which is the maximum value of the probabilities of appearance is set as the object disappearance anomaly score.

After step S65 is performed, the anomaly detection unit 17 calculates an image anomaly score based on the object appearance anomaly score calculated in step S64 and the object disappearance anomaly score calculated in step S65 (step S66). Specifically, the anomaly detection unit 17 calculates a weighted average of the object appearance anomaly score and the object disappearance anomaly score. More specifically, the anomaly detection unit 17 calculates the image anomaly score, using a parameter a set in advance by the user, from an expression of (image anomaly score)=α×(object appearance anomaly score)+(1−α)×(object disappearance anomaly score). If α=1/2, the anomaly score of the target image I91 is 7/8 ((1/2)×(3/4)+(1/2)×1=7/8).

In steps S67 to S68, whether or not the target image has an anomaly is determined based on the image anomaly score, and the determination result is output. Steps S67 and S68 are similar to steps S27 and S28 in FIG. 4, and thus the description thereof is omitted.

Thus, the processing performed by the anomaly detection apparatus 10 according to the eighth embodiment at the time of anomaly detection ends.

In the examples of FIGS. 22 and 23, the object appearance anomaly score is the image anomaly score in the first embodiment, and thus, the image anomaly score is 3/4. This is because a butterfly that does not appear much in the training data set is shown in the target image I91. On the other hand, in the eighth embodiment, the image anomaly score is 7/8 which is larger than the image anomaly score of 3/4 according to the first embodiment. This is based on not only the fact that a butterfly which does not appear much in the training data set is shown in the target image I91 but also the fact that a bucket that appears in the entire training data set is not shown in the target image I91. Therefore, according to the eighth embodiment, it is possible to determine whether or not an anomaly occurs in consideration of not only the appearance of an anomaly object but also the disappearance of an object to appear.

### Ninth Embodiment

An anomaly detection apparatus according to the ninth embodiment acquires a video as a sample and calculates an anomaly score for each video. The anomaly detection apparatus according to the ninth embodiment will be described below. In the description of the present embodiment, the description of the same parts as those of the first embodiment will be omitted or simplified.

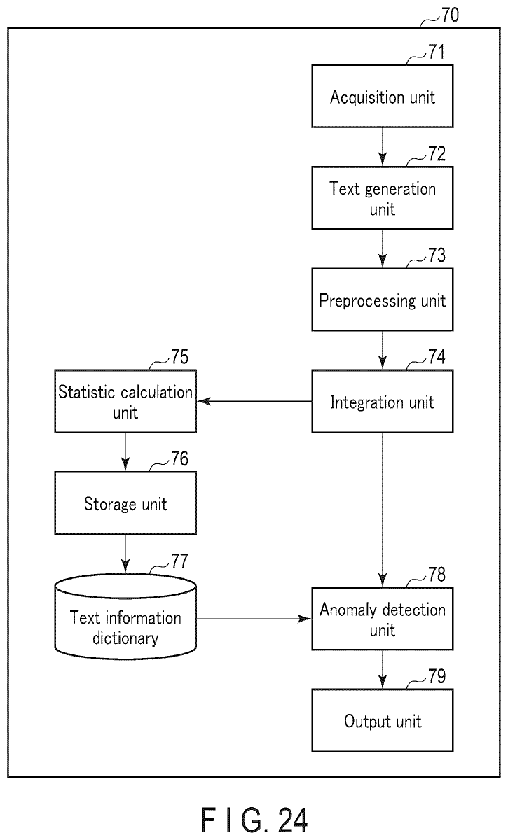

FIG. 24 is a functional block diagram illustrating an example of an anomaly detection apparatus 70 according to the ninth embodiment. As illustrated in FIG. 24, the anomaly detection apparatus 70 includes an acquisition unit 71, a text generation unit 72, a preprocessing unit 73, an integration unit 74, a statistic calculation unit 75, a storage unit 76, a text information dictionary 77, an anomaly detection unit 78, and an output unit 79. The storage unit 76 and the output unit 79 are substantially the same as the storage unit 15 and the output unit 18 according to the first embodiment, respectively.

The acquisition unit 71 acquires a video as a sample. At the time of training, the acquisition unit 71 acquires a training data set including a plurality of videos. The training data set includes a plurality of normal videos. At the time of anomaly detection, the acquisition unit 71 acquires an inference data set including at least one video. The video is one data set including a plurality of time-series frames.

The text generation unit 72 generates a plurality of texts respectively corresponding to a plurality of frames included in the video. A method for generating the text is similar to that of the first embodiment. In addition, the text may be generated every several frames or the like without generating the text for all the frames of the video. With this operation, a plurality of text groups is output from one video. The text generation unit 72 executes processing on both a training video and a target video.

The preprocessing unit 73 performs word segmentation on the text included in the text group of each video. As in the first embodiment, preprocessing such as part-of-speech determination or stemming other than the word segmentation may be performed. With this operation, word strings of the number of processed frames are obtained for one video. The preprocessing unit 73 executes processing on both the training video and the target video.

The integration unit 74 integrates a plurality of texts relating to one video into one text representing the content of one video. Specifically, for each of the plurality of frames included in one video, the integration unit 74 generates a word string without duplication by selecting a word that appears once or more in one video from words belonging to a specific part of speech included in the target text. The integration is performed by taking the logical sum of the elements of all the word strings. As a specific example, a word string (cat, dog) obtained from a first frame of a first video and a word string (person, dog) obtained from a second frame of the first video are integrated to generate a word string (person, cat, dog). With this operation, one word string is obtained for each video. The word string obtained by the integration unit 74 is regarded as a word string corresponding to one video, and the subsequent processing is performed in the same manner as in the first embodiment, so that the anomaly score of each video can be calculated.

The statistic calculation unit 75 calculates a statistic for each word included in the word string generated by the integration unit 74. The anomaly detection unit 78 determines whether or not the target video that is a target sample has an anomaly based on the statistic associated with each word in the text information dictionary 77.

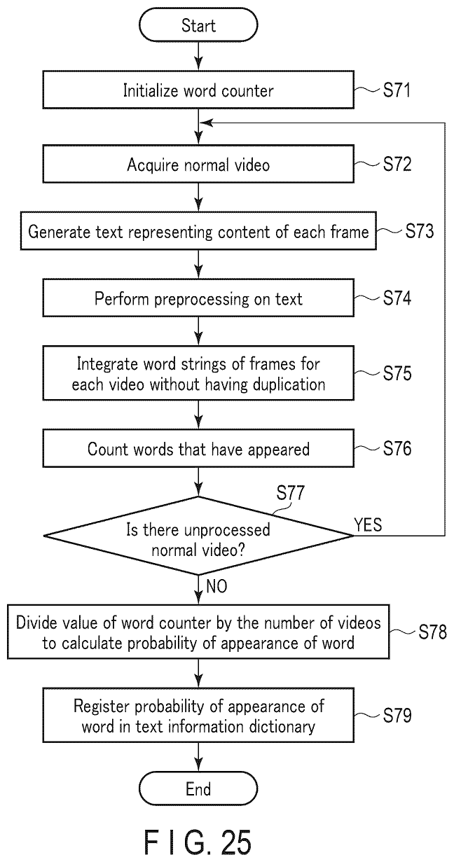

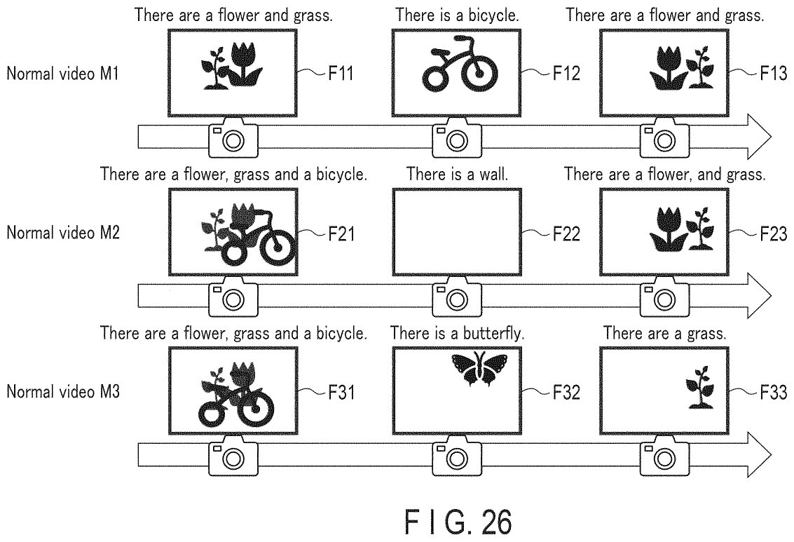

FIG. 25 is a diagram illustrating a flow of processing performed by the anomaly detection apparatus 70 according to the ninth embodiment at the time of training. FIG. 26 is a diagram illustrating three normal videos M1, M2, and M3 which are examples of a training data set according to the ninth embodiment. Each of the normal videos M1, M2, and M3 includes three frames Fij (i (i=1, 2, 3) is a subscript indicating the number of the video to which the frame belongs, and j (j=1, 2, 3) is a subscript indicating the number of the frame). Each of the normal videos M1, M2, and M3 is captured by a moving camera. The text indicated at the top of each frame Fij is a caption generated in step S73.

Step S71 is similar to step S11 illustrated in FIG. 2. After step S71 is performed, the acquisition unit 71 acquires a normal video (step S72). First, it is assumed that the normal video M1 illustrated in FIG. 26 is acquired.

After step S72 is performed, the text generation unit 72 generates a text representing the content of each of three frames included in the normal video acquired in step S72 (step S73). For example, a caption generation model is used to generate a caption representing the content of each frame in sentences. As a result, “There are a flower and grass.” is generated for a frame F11 of the normal video M1, “There is a bicycle.” is generated for a frame F12, and “There are a flower and grass.” is generated for a frame F13 as illustrated in FIG. 26.

After step S73 is performed, the preprocessing unit 73 performs preprocessing on the text generated in step S73 (step S74). Specifically, the preprocessing unit 73 performs word segmentation on the text, and further extracts words belonging to a noun. As a result, a word string (flower, grass) is obtained from the frame F11, a word string (bicycle) is obtained from the frame F12, and a word string (flower, grass) is obtained from the frame F13.

After step S74 is performed, the integration unit 74 integrates the word strings of the frames output in step S74 so as not to cause duplication for each normal video (step S75). Specifically, the integration unit 74 integrates the above-described three word strings (flower, grass), (bicycle), and (flower, grass) so as not to have duplication of words, and generates a word string (flower, grass, bicycle).

Steps S76 to S79 are similar to steps S15 to S18 in FIG. 2, and thus the description thereof is omitted. It is to be noted that, in step S78, the statistic calculation unit 75 calculates the probability of appearance of each word by dividing the value of a word counter of each word by the number of normal videos included in the training data set. As a result, the probability of appearance of the word “flower” is 1, the probability of appearance of the word “grass” is 1, the probability of appearance of the word “bicycle” is 1, the probability of appearance of the word “wall” is 1/3, and the probability of appearance of the word “butterfly” is 1/3.

Thus, the processing performed by the anomaly detection apparatus 70 at the time of training according to the ninth embodiment ends.

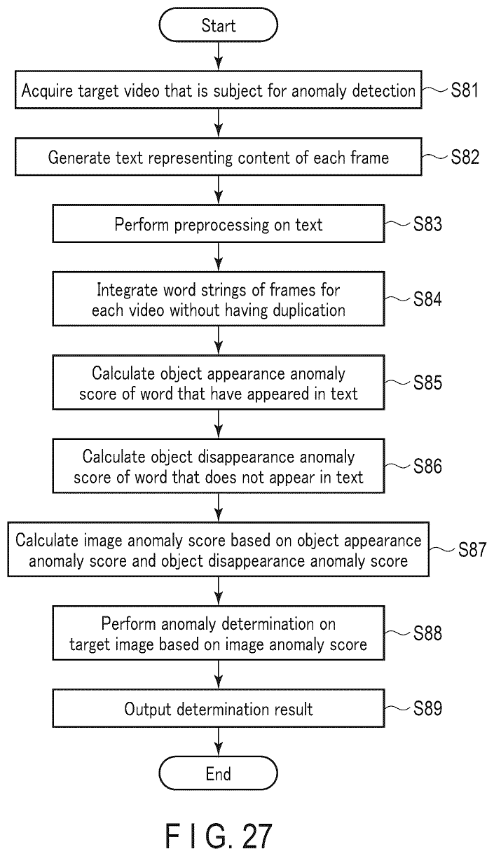

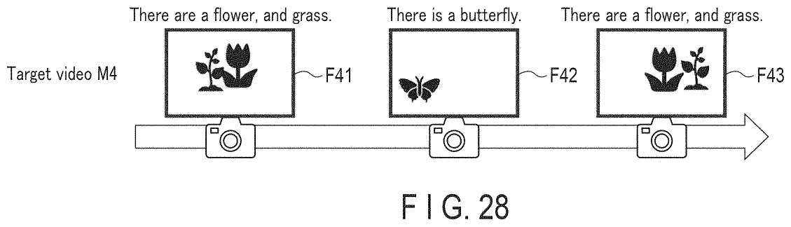

FIG. 27 is a diagram illustrating a flow of processing performed by the anomaly detection apparatus 70 according to the ninth embodiment at the time of anomaly detection. FIG. 28 is a diagram illustrating one target video M4 which is an example of an inference data set according to the ninth embodiment. The target video M4 is assumed to be an anomaly video because a bicycle that should originally appear is not shown.

Steps S81 to S83 are similar to steps S21 to S23 illustrated in FIG. 4. Grass and a flower are shown in a first frame F41 of the target video M4 illustrated in FIG. 28, a butterfly is shown in a second frame F43, grass and a flower are shown in a third frame F43, a target text representing the content of the first frame F41 includes the word “grass” and the word “flower”, a target text representing the content of the second frame F42 includes the word “butterfly”, and a target text representing the content of the third frame F43 includes the word “grass” and the word “flower”.

After step S83 is performed, the integration unit 74 integrates the words of the frames F41, F42, and F43 so that there is no duplication (step S84). As a result, a word string of (flower, grass, butterfly) is obtained.

After step S84 is performed, the anomaly detection unit 78 calculates an object appearance anomaly score for the word included in the word string obtained by the integration in step S84, in other words, the word appearing in the text of the normal video (step S85). The method for calculating the object appearance anomaly score is similar to that of the eighth embodiment, and thus the description thereof will be omitted. In step S85, the object appearance anomaly score 2/3 is obtained for the word “butterfly”.

After step S86 is performed, the anomaly detection unit 78 calculates an object disappearance anomaly score for the word that is not included in the word string obtained by the integration in step S84, in other words, the word that does not appear in the text of the normal video (step S86). The method for calculating the object disappearance anomaly score is the same as that in the eighth embodiment, and thus the description thereof will be omitted. In step S86, the object disappearance anomaly score 1 is obtained for the word “bicycle”.

After step S86 is performed, the anomaly detection unit 78 calculates an image anomaly score based on the object appearance anomaly score calculated in step S85 and the object disappearance anomaly score calculated in step S86 (step S87). The method for calculating the image anomaly score is similar to that of the eighth embodiment, and thus the description thereof will be omitted. Specifically, if the weighted average is calculated with α=0.5, the anomaly score of the normal video M4 is 5/6 (1/2×2/3+1/2×1=5/6).

Steps S88 and S89 are similar to steps S27 and S28 in FIG. 4, and thus the description thereof is omitted.

Thus, the processing performed by the anomaly detection apparatus 70 according to the ninth embodiment at the time of anomaly detection ends.

According to the ninth embodiment, it is possible to determine whether or not the target video has an anomaly. In addition, by considering the object appearance anomaly score and the object disappearance anomaly score, it is also possible to detect the appearance of an anomaly object and the disappearance of a normal object.

### Tenth Embodiment

An anomaly detection apparatus according to the tenth embodiment uses a feature value extraction unit instead of a statistic calculation unit, and uses an anomaly detection model instead of a text information dictionary. The anomaly detection apparatus according to the tenth embodiment will be described below. In the description of the present embodiment, the description of the same parts as those of the first embodiment will be omitted or simplified.

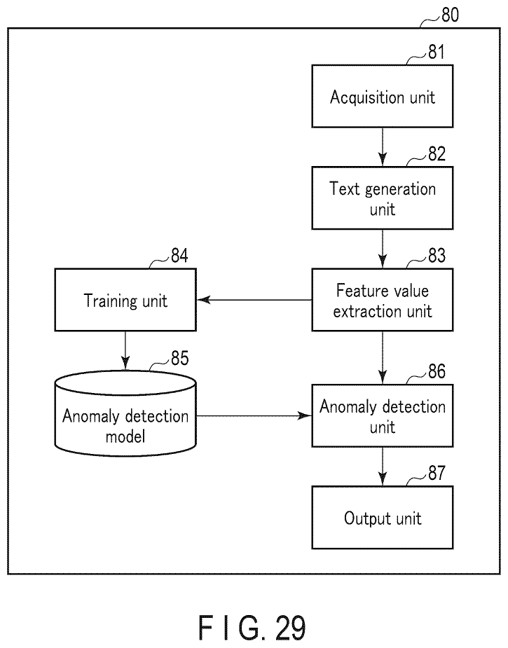

FIG. 29 is a functional block diagram illustrating an example of an anomaly detection apparatus 80 according to the tenth embodiment. As illustrated in FIG. 29, the anomaly detection apparatus 80 includes an acquisition unit 81, a text generation unit 82, a feature value extraction unit 83, a training unit 84, an anomaly detection model 85, an anomaly detection unit 86, and an output unit 87. The acquisition unit 81, the text generation unit 82, and the output unit 87 are substantially the same as the acquisition unit 11, the text generation unit 12, and the output unit 18 according to the first embodiment, respectively.

The feature value extraction unit 83 extracts, based on a target text generated by the text generation unit 82, a feature value related to the target text. The feature value extraction unit 83 also extracts, based on a training text generated by the text generation unit 82, a feature value related to the training text. As the feature value, a feature vector is used. It is assumed that a sentence embedding model using a transformer, or the like is used for the transformation into the feature vector, but a technology such as Bag of Words or Doc2Vec may be used.

The training unit 84 trains an untrained machine learning model based on the feature value regarding the training text extracted by the feature value extraction unit 83, inputs a sample, and generates an anomaly detection model that detects an anomaly of the sample. In a case where a training data set includes both an anomaly sample and a normal sample and a label is annotated, a supervised classification model such as a neural network or a support vector machine may be used as the anomaly detection model. Furthermore, in a case where the training data set includes only normal samples, a model that determines an anomaly according to a distance to a sample in the vicinity of the feature value space may be used. In this case, the training unit 84 stores the feature value of the training data set as a model. In addition, a network that brings a normal feature value close to a Gaussian distribution may be trained as in a method using Normalizing flow described in Non-Patent Literature 3 (Marco Rudolph, Bastian Wandt, Bodo Rosenhahn, Same Same But DifferNet: Semi-Supervised Defect Detection with Normalizing Flows, WACV 2021).

The anomaly detection unit 86 determines whether or not a target sample has an anomaly based on the anomaly detection model generated by the training unit 84 and the feature value related to the target text extracted by the feature value extraction unit 83.

As described above, the anomaly detection apparatus 80 according to the tenth embodiment converts a text into a feature value and determines whether or not the sample has an anomaly based on the feature value. The feature value has a value reflecting not only an object included in the sample but also a complicated relationship such as a co-occurrence relationship between objects included in the sample. Therefore, the anomaly detection apparatus 80 can determine the occurrence of an anomaly in consideration of a complicated relationship such as a co-occurrence relationship between objects included in the sample as compared with the case of determining the occurrence of an anomaly using the statistic such as the probability of appearance of word.

### <Hardware Configuration>

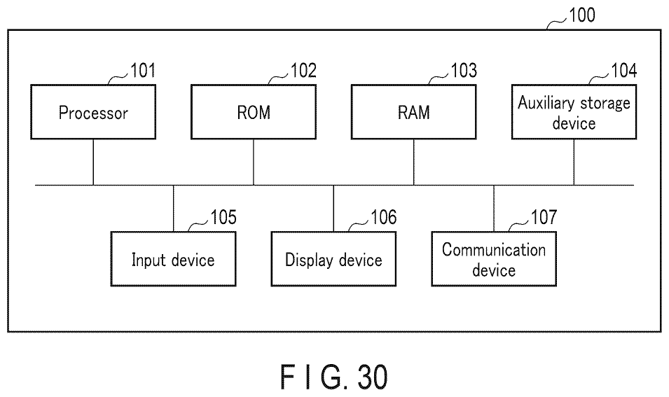

FIG. 30 is a diagram illustrating a hardware configuration of the anomaly detection apparatuses 10 to 90 according to the first to tenth embodiments. In FIG. 30, the anomaly detection apparatuses 10 to 90 according to the first to tenth embodiments are collectively referred to as anomaly detection apparatus 100. As illustrated in FIG. 30, the anomaly detection apparatus 100 is a computer including a processor 101, a read only memory (ROM) 102, a random access memory (RAM) 103, an auxiliary storage device 104, an input device 105, a display device 106, and a communication device 107. The processor 101, the ROM 102, the RAM 103, the auxiliary storage device 104, the input device 105, the display device 106, and the communication device 107 exchange data and various signals via a bus (Bus).

The processor 101 is an integrated circuit that controls the entire operation of the anomaly detection apparatus 100. For example, the processor 101 includes a central processing unit (CPU), a graphics processing unit (GPU), a digital signal processor (DSP), and/or a floating-point unit (FPU). The processor 101 may include an internal memory or an I/O interface. The processor 101 executes the above-described various processes by interpreting and calculating a program stored in advance into the ROM 102, the auxiliary storage device 104, or the like. A part or the whole of the processor 101 may be implemented by hardware such as an application specific integrated circuit (ASIC) or a field programmable gate array (FPGA).

The ROM 102 is a nonvolatile memory that stores various data. For example, the ROM 102 stores data, setting values, and the like used during the execution of various processes by the processor 101. The ROM 102 may have a non-transitory computer readable storage medium that stores a program to be executed by the processor 101.

The RAM 103 is a volatile memory used for reading and writing data. The RAM 103 temporarily stores data to be used during the execution of various processes by the processor 101. The RAM 103 provides a work area for the processor 101.

The auxiliary storage device 104 is a nonvolatile memory that stores various data. For example, the auxiliary storage device 104 stores data and setting values used during the execution of various processes by the processor 101, data generated by various processes in the processor 101, and the like. The auxiliary storage device 104 includes a hard disk drive (HDD), a solid state drive (SSD), an integrated circuit storage apparatus, and the like. Note that the auxiliary storage device 104 may include a non-transitory computer readable storage medium that stores a program executed by the processor 101.

The input device 105 receives the inputs of various operations from an operator. As the input device 105, a keyboard, a mouse, various switches, a touch pad, a touch panel display, and the like can be used. The electric signal corresponding to the input of the received operation is supplied to the processor 101.

The display device 106 displays various types of data under the control of the processor 101. As the display device 106, a cathode-ray tube (CRT) display, a liquid crystal display, an organic electro luminescence (EL) display, a light-emitting diode (LED) display, a plasma display, or any other display can be appropriately used. The display device 106 may be a projector.

The communication device 107 includes a communication interface such as a network interface card (NIC) for performing data communication with various devices connected to the anomaly detection apparatus 100 via a network. Note that an electric signal may be supplied from a computer connected via the communication device 107 or an input device included in the computer, or various types of data may be displayed on a display device or the like included in the computer connected via the communication device 107. The input device 105 can be replaced with a computer connected via the communication device 107 or an input device included in the computer, and the display device 106 can be replaced with a display device or the like included in the computer connected via the communication device 107.

The anomaly detection apparatus 100 does not need to include all of the processor 101, the ROM 102, the RAM 103, the auxiliary storage device 104, the input device 105, the display device 106, and the communication device 107. If necessary, some of the ROM 102, the RAM 103, the auxiliary storage device 104, the input device 105, the display device 106, and the communication device 107 may not be provided. The anomaly detection apparatus 100 may be provided with any additional hardware device useful for executing the processing according to the present embodiment. The anomaly detection apparatus 100 does not need to be physically configured by one computer, and may be configured by a computer system including a plurality of computers communicably connected via a wired or network line or the like. A series of processing according to the present embodiment can be freely allocated to the plurality of processors 101 mounted on the plurality of computers. All the processors 101 may execute all the processes in parallel, or a specific process may be allocated to one or some of the processors 101, and a series of processing according to the present embodiment may be executed by the computer system as a whole.

According to the present embodiment described above, it is possible to provide an anomaly detection apparatus robust to a change in an imaging environment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anomaly detection apparatus comprising a processor that:
acquires a first sample that is a subject for anomaly detection;
generates, using a trained model, a first text from the first sample, the first text representing a content of the first sample;
determines whether or not the first sample has an anomaly based on a statistic associated with all or a part of the first text in a text information dictionary, the text information dictionary associating all or a part of a second text representing a content of a second sample included in a training data set with a statistic related to a degree of appearance of all or a part of the second text in the training data set; and
outputs a determination result of whether or not the first sample has an anomaly.

2. The anomaly detection apparatus according to claim 1, wherein
the trained model is a caption generation model, and
the processor is configured to apply the first sample to the caption generation model to generate, as the first text, a caption describing the content of the first sample.

3. The anomaly detection apparatus according to claim 1, wherein
the trained model is a model that uses a sample and a prompt as an input and outputs a text for a combination of the sample and the prompt, and
the processor is further configured to:
acquire a prompt for the content of the first sample; and
apply the first sample and the prompt to the model to generate the first text.

4. The anomaly detection apparatus according to claim 1, wherein
the processor is configured to:
acquire a plurality of the second samples included in the training data set;
generate, from each of the second samples, the second text representing the content of the second sample using the trained model; and
calculate the statistic of all or a part of the second text for each of the second samples.

5. The anomaly detection apparatus according to claim 4, wherein
the processor is configured to:
calculate, for each of the second samples, a frequency of appearance of all or a part of the second text corresponding to the second sample, calculate the statistic based on the frequency of appearance,
calculate an anomaly score of the first text based on the statistic associated with all or a part of the first text, determine the first sample as anomaly in a case where the anomaly score is larger than a threshold, and determine the first sample as normal in a case where the anomaly score is smaller than the threshold.

6. The anomaly detection apparatus according to claim 5, wherein
the second sample is a normal sample including no anomaly, and
the processor is configured to:
calculate, as the statistic, a probability of appearance based on the frequency of appearance of the second text, and
calculate an anomaly score of the first text based on a probability of appearance associated with the first text.

7. The anomaly detection apparatus according to claim 4, wherein
the processor is further configured to perform
preprocessing of dividing the first text and/or the second text into a plurality of sections and/or preprocessing of excluding information unnecessary for anomaly detection from the first text and/or the second text.

8. The anomaly detection apparatus according to claim 4, wherein
the processor is configured to calculate the statistic for a word or a combination of words belonging to a specific part of speech included in the second text,
the text information dictionary associates the word or the combination of words with the statistic, and
the processor is configured to:
specify, for each word or combination of words belonging to the specific part of speech included in the first text, a statistic associated with the word or the combination in the text information dictionary, calculate a word anomaly score based on the statistic that has been specified, determine the first sample as anomaly in a case where a maximum value of the word anomaly score that has been calculated is larger than a threshold, and determine the first sample as normal in a case where the maximum value is smaller than the threshold.

9. The anomaly detection apparatus according to claim 8, wherein
the first sample and the second sample are an image, and
the processor is further configured to estimate an image region corresponding to an anomaly word in which the statistic indicates an anomaly in the first sample.

10. The anomaly detection apparatus according to claim 9, wherein the processor is configured to estimate the image region based on gradient information regarding the anomaly word of the trained model.

11. The anomaly detection apparatus according to claim 9, wherein the processor is configured to estimate the image region by performing object detection using the anomaly word as a prompt.

12. The anomaly detection apparatus according to claim 4, wherein
the processor is further configured to
perform clustering on the training data set to divide the second samples into a plurality of clusters, and
calculate the statistic for each of the clusters,
the text information dictionary associates all or a part of the second text with the statistic for an identifier of each of the clusters, and
the processor is configured to
identify a first cluster to which the first sample belongs from among the clusters, and
determine whether or not the first sample has an anomaly based on the statistic associated with the identifier of the first cluster in the text information dictionary.

13. The anomaly detection apparatus according to claim 12, wherein the processor is configured to perform the clustering by using an unsupervised clustering method.

14. The anomaly detection apparatus according to claim 12, wherein
the processor is configured to:
perform the clustering based on metadata of the second sample; and
determine a cluster to which the first sample belongs based on metadata of the first sample.

15. The anomaly detection apparatus according to claim 4, wherein
the first sample and the second sample are a data set including a plurality of time-series frames, and
the processor is configured to:
generate a plurality of texts respectively corresponding to the time-series frames; and
integrate the texts into a first text or a second text that represents a content of the data set.

16. The anomaly detection apparatus according to claim 15, wherein
the processor is configured to:
generate, for each of the time-series frames, a word string without duplication by selecting a word that appears once or more in the data set from words belonging to a specific part of speech included in the first text;
calculate the statistic for each word included in the word string; and
determine whether or not the first sample has an anomaly based on the statistic associated with each word included in the word string in the text information dictionary.

17. The anomaly detection apparatus according to claim 1, wherein
the processor is further configured to:
input a text and/or information regarding a statistic of the text according to an instruction from a user; and
edit the text information dictionary based on the input information.

18. The anomaly detection apparatus according to claim 1, wherein the processor is further configured to, based on a sample and a text representing a content of the sample, train an untrained model so as to input the sample and output the text to generate the trained model.

19. The anomaly detection apparatus according to claim 4, wherein
the processor is further configured to extract a feature value from all or a part of the second text,
the text information dictionary associates the statistic and the feature value with all or a part of the second text, and
the processor is configured to: calculate an anomaly score of all or a part of the first text based on the statistic associated with all or a part of the first text and the feature value in the text information dictionary; determine the first sample as anomaly in a case where a maximum value of the anomaly score that has been calculated is larger than a threshold; and determine the first sample as normal in a case where the maximum value is smaller than the threshold.

20. The anomaly detection apparatus according to claim 19, wherein
the processor is configured to:
calculate, based on a frequency of appearance of a word or a combination of words belonging to the specific part of speech included in the second text, a probability of appearance of the word or the combination as the statistic; and
calculate, based on the probability of appearance associated with a word or a combination of words belonging to the specific part of speech included in the first text and the feature value in the text information dictionary, the anomaly score of the word or the combination.

21. The anomaly detection apparatus according to claim 4, wherein
the processor is configured to:
calculate, based on a frequency of appearance of a word or a combination of words belonging to a specific part of speech included in the second text, a probability of appearance of the word or the combination as the statistic;
calculate an object appearance anomaly score based on the probability of appearance associated with a word or a combination of words belonging to the specific part of speech included in the first text in the text information dictionary; calculate an object disappearance anomaly score based on the probability of appearance associated with a word not included in the first text in the word or combination of words stored in the text information dictionary; and determine whether or not the first sample has an anomaly based on the object appearance anomaly score and the object disappearance anomaly score.

22. The anomaly detection apparatus according to claim 1, wherein
the processor is configured to:
extract a first feature value related to the first text based on the first text and a second feature value related to the second text based on the second text;
train an anomaly detection model that detects an anomaly of the second sample using the second feature value; and
determine whether or not the first sample has an anomaly based on the anomaly detection model and the first feature value.

23. The anomaly detection apparatus according to claim 1, wherein the processor is further configured to display the first sample, the first text, and the determination result on a display device side by side.

24. The anomaly detection apparatus according to claim 8, wherein
the processor is configured to:
display the first sample, the first text, and the determination result side by side on a display device; and
use different visual effects for displaying a specific word having the maximum value in the first text between a case where the maximum value is larger than the threshold and a case where the maximum value is smaller than the threshold.

25. The anomaly detection apparatus according to claim 24, wherein the processor is configured to display the maximum value side by side with the specific word.

26. An anomaly detection method performed by a processor, the anomaly detection method comprising:
acquiring a first sample that is a subject for anomaly detection;
generating, using a trained model, a first text from the first sample, the first text representing a content of the first sample;
determining whether or not the first sample has an anomaly based on a statistic associated with all or a part of the first text in a text information dictionary, the text information dictionary associating all or a part of a second text representing a content of a second sample included in training data with a statistic related to a degree of appearance of all or a part of the second text in the training data; and
outputting a determination result of whether or not the first sample has an anomaly.

27. A non-transitory computer readable storage medium including computer executable instructions, wherein the instructions, when executed by a processor, cause the processor to perform operations comprising:
acquiring a first sample that is a subject for anomaly detection;
generating, using a trained model, a first text from the first sample, the first text representing a content of the first sample;
determining whether or not the first sample has an anomaly based on a statistic associated with all or a part of the first text in a text information dictionary, the text information dictionary associating all or a part of a second text representing a content of a second sample included in training data with a statistic related to a degree of appearance of all or a part of the second text in the training data; and
outputting a determination result of whether or not the first sample has an anomaly.
